(19) United States
(12) Patent Application Publication
(10) Pub. No.: US 2007/0293991 A1
(43) Pub. Date: Dec. 20, 2007

(54) Method, system and apparatus for controlling power to a computing device on a vehicle

(75) Inventors: Jimmy Joe Pasquin, Woodbridge (CA); Elgin Lorne McMillan, Waterloo (CA)

Correspondence Address: FETHERSTONHAUGH - SMART & BIGGAR, 1000 DE LA GAUCHETIERE WEST, SUITE 3300, MONTREAL, QC, H3B 4W5, US

(73) Assignee: BCE INC.

(21) Appl. No.: 11/455,712

(22) Filed: Jun. 20, 2006

(51) Int. Cl. G05D 1/00

(52) U.S. Cl. 701/1

(57) ABSTRACT

According to embodiments of the present invention, a method, system and apparatus for controlling power to a computing device on a vehicle is disclosed, the computing device powered from a local power supply. An operational state of the vehicle is detected. The power level of the computing device is controlled based upon the operational state of the vehicle. The power level of the computing device is controlled to a first power level when the vehicle is in a first operational state and controlled to a second power level when the vehicle is in a second operational state.

### FIELD OF THE INVENTION

This invention relates generally to a computing device on a vehicle and more specifically a method, system and apparatus for controlling power to a computing device on a vehicle.

### BACKGROUND OF THE INVENTION

Within the trucking industry there has been a trend towards monitoring both tractors and the trailers that are pulled by the tractors. For example, a tractor/trailer combination may be equipped with a GPS device to monitor their position. The tractor/trailer combination could also be equipped with a computing device to monitor the systems of the tractor/trailer combination. The computing devices are often in wireless communication with an entity monitoring the tractor/trailer combination, for example the trucking company which owns the vehicles or a company hired to monitor the devices. Until recently these devices were located only in the tractor and the position and systems of the trailer were monitored only when the trailer was coupled to the tractor.

However it has become common to mount monitoring devices in trailers in addition to those that are mounted in tractors. For example, a trucking company might be interested in the position of both the tractor and the trailer, especially as the trailer is often decoupled from the tractor and parked for a period of time before it is used again. Or a trailer containing a shipment might be handed off from one tractor to another tractor and the company may then need to track the position and/or systems of the trailer independent of the tractor it is coupled to.

Computing devices which are mounted on a vehicle, including a trailer, may draw power from either a local power supply, such as a battery, specifically dedicated to the computing device or alternatively from a local power supply that supplies power generally to the vehicle. However there is a danger that the computing device that is always on may exhaust the power supply, leading to a failure of both the computing device and potentially the vehicle systems which draw on the same power supply. Within trailers, this has been addressed by providing a means to charge the power supply, for example by equipping it with solar panels to either power the device and/or charge an associated battery. However solar panels add significant costs and have the disadvantage of having to be mounted externally on the trailer, and thus are subject to damage and require regular cleaning to remain effective.

Certain types of trailers may contain their own local power supply to power various systems local to the trailer, for example temperature control systems or “reefers”. Reefers are generally equipped with on-board fuel tanks, an engine that runs a compressor, a battery and a battery charging system connected to the engine, as well as electronic controls to start and stop the engine as required based on temperature parameters. In reefers that are further equipped with a computing device, the computing device may be powered from the reefer power supply. However the computing device then acts as a constant drain on the power supply and may potentially drain the reefer battery, leading to a failure in the temperature control system and/or a failure of the ignition system of the engine. If the trailer is storing perishable items this may lead to the spoiling of the perishable items.

There remains a need therefore for an improved method, system and apparatus for controlling power to a computing device on a vehicle.

### SUMMARY OF THE INVENTION

A first broad aspect of the invention seeks to provide a method of controlling power to a computing device on a vehicle, the computing device powered from a local power supply. The method comprises detecting an operational state of the vehicle. The method further comprises controlling the power level of the computing device based upon the operational state of the vehicle, wherein the power level of the computing device is controlled to a first power level when the vehicle is in a first operational state and controlled to a second power level when the vehicle is in a second operational state.

In some embodiments of the present invention, detecting an operational state of the vehicle comprises detecting an in-use state of the vehicle and detecting a not-in-use state of the vehicle. In some embodiments the in-use state of the vehicle comprises the vehicle being in motion and the not-in-use state of the vehicle comprises the vehicle being stationary.

In other embodiments of the present invention, detecting the operational state of the vehicle comprises detecting an operational state of at least one vehicle system. In some embodiments detecting the operational state of the at least one vehicle system comprises detecting an operational state of a braking system, and the first operational state comprises the brake system being disengaged and the second operational state comprises the brake system being engaged. In some of these embodiments, the brake system comprises an emergency brake system.

In other embodiments of the present invention, detecting the operational state of at least one vehicle system comprises detecting an operational state of an engine system, wherein the first operational state comprises the engine system being in an on state and the second operational state comprises the engine being in an off state.

In other embodiments of the present invention, detecting the operational state of at least one vehicle system comprises detecting an operational state of an ignition system, wherein the first operational state comprises the ignition system being in an engaged state and the second operational state comprises the ignition system being in a disengaged state.

In other embodiments of the present invention, detecting the operational state of at least one vehicle system comprises detecting an operational state of an exhaust system, wherein the first operational state comprises the exhaust system being in an in-use state and the second operational state comprises the exhaust system being in a not-in-use state.

In other embodiments of the present invention, detecting the operational state of at least one vehicle system comprises detecting an operational state of a transmission system, wherein the first operational state comprises the transmission system being in an engaged state and the second operational state comprises the transmission system being in a disengaged state.

In other embodiments of the present invention, detecting the operational state of at least one vehicle system comprises detecting an operational state of a coupling system, wherein the first operational state comprises the coupling system being coupled and the second operational state comprises the coupling system being uncoupled.

In further embodiments of the first broad aspect, detecting the operational state of the vehicle comprises detecting a state of the vehicle environment. In some embodiments, detecting a state of the vehicle environment comprises detecting the motion of the vehicle, wherein the first operational state comprises the vehicle being in motion and the second operational state comprises the vehicle being stationary.

In other embodiments, detecting a state of the vehicle environment comprises detecting the vibration of the vehicle, wherein the first operational state comprises the vehicle vibrating and the second operational state comprises the vehicle not vibrating.

In other embodiments, detecting a state of the vehicle environment comprises detecting the proximity of the vehicle to a second vehicle, wherein the first operational state comprises the vehicle being in proximity to the second vehicle and the second operational state comprises the vehicle not being in proximity to the second vehicle.

In other embodiments, detecting a state of the vehicle environment comprises detecting the presence of a vehicle driver, wherein the first operational state comprises a driver being present and the second operational state comprises the driver not being present.

In further embodiments of the first broad aspect, detecting the operational state of the vehicle comprises detecting a state of the power supply.

In other embodiments of the first broad aspect, detecting the operational state of the vehicle comprises a plurality of detecting the operational state of at least one vehicle system, detecting a state of the vehicle environment, and detecting a state of the power supply.

In yet further embodiments the first broad aspect, the method further comprises generating an indicator based on the operational state of the vehicle, and wherein the controlling the power level of the computing device is based on the indicator. In other embodiments of the first broad aspect, the second power level is lower than the first power level. In further embodiments, at the second power level, the computing device is in an off state and, at the first power level, the computing device is in a fully functional state. In yet further embodiments, at the second power level, the computing device is in a partially functional state.

In other embodiments, the computing device comprises a plurality of components; and at the second power level, at least one first component of the computing device is functional and at least one second component of the computing device is not functional. In yet other embodiments, the at least one first component comprises a wireless communication component, and the at least one second component comprises a GPS component.

In some embodiments of the first broad aspect, the computing device is controlled to a third power level when the vehicle is in a third operational state, and at the third power level the computing device is in a partially functional state. In some embodiments, at the third power level, at least one first component of the computing device is functional and at least one second component of the computing device is not functional.

In other embodiments of the first broad aspect, the computing device comprises a plurality of components; and wherein at least one component of the computing device is always powered.

A second broad aspect of the present invention seeks to provide an apparatus for controlling power to a computing device on a vehicle, the computing device powered from a local power supply. The apparatus includes a detection apparatus for detecting an operational state of the vehicle. The apparatus further includes a power control apparatus, communicatively coupled to the detection apparatus, the power control apparatus operable to control the power level of the computing device based upon the operational state of the vehicle, wherein the power level of the computing device is controlled to a first power level when the vehicle is in a first operational state and controlled to a second power level when the vehicle is in a second operational state.

In some embodiments of the first broad aspect, the detection apparatus comprises at least one detector in communication with at least one vehicle system, wherein the at least one detector is operable to detect the operational state of the vehicle by detecting the operational state of the at least one vehicle system. In some embodiments, to detect the operational state of the at least one vehicle system, the at least one detector is operable to detect the operational state of a braking system, and wherein the first operational state comprises the brake system being disengaged and the second operational state comprises the brake system being engaged. In yet further embodiments the brake system comprises an emergency brake system.

In other embodiments of the present invention, to detect the operational state of the at least one vehicle system, the at least one detector is operable to detect the operational state of an engine system; and wherein the first operational state comprises the engine system being in an on state and the second operational state comprises the engine being in an off state.

In other embodiments of the present invention, to detect the operational state of the at least one vehicle system, the at least one detector is operable to detect the operational state of an ignition system; and wherein the first operational state comprises the ignition system being in an engaged state and the second operational state comprises the ignition system being in a disengaged state.

In other embodiments of the present invention, to detect the operational state of the at least one vehicle system, the at least one detector is operable to detect the operational state of an exhaust system; and wherein the first operational state comprises the exhaust system being in an in-use state and the second operational state comprises the exhaust system being in a not-in-use state.

In other embodiments of the present invention, to detect the operational state of the at least one vehicle system, the at least one detector is operable to detect the operational state of a transmission system; and wherein the first operational state comprises the transmission system being in an engaged state and the second operational state comprises the transmission system being in a disengaged state.

In other embodiments of the present invention, to detect the operational state of the at least one vehicle system, the at least one detector is operable to detect the operational state of a coupling system; and wherein the first operational state comprises the coupling system being coupled and the second operational state comprises the coupling system being uncoupled. In further embodiments the vehicle comprises a trailer.

In other embodiments of the first broad aspect, the detection apparatus comprises at least one detector operable to detect the operational state of the vehicle by detecting a state of the vehicle environment. In further embodiments the at least one detector is operable to detect the motion of the vehicle, wherein the first operational state comprises the vehicle being in motion and the second operational state comprises the vehicle being stationary.

In other embodiments of the present invention, the at least one detector is operable to detect the vibration of the vehicle, wherein the first operational state comprises the vehicle vibrating and the second operational state comprises the vehicle not vibrating.

In other embodiments of the present invention, the at least one detector is operable to detect the proximity of the vehicle to a second vehicle, wherein the first operational state comprises the vehicle being in proximity to the second vehicle and the second operational state comprises the vehicle not being in proximity to the second vehicle.

In other embodiments of the present invention, the at least one detector is operable to detect the presence of a vehicle driver, wherein the first operational state comprises a driver being present and the second operational state comprises the driver not being present.

In other embodiments of the first broad aspect, detecting the operational state of the vehicle comprises detecting a state of the power supply.

In yet other embodiments of the first broad aspect, detecting the operational state of the vehicle comprises a plurality of detecting the operational state of at least one vehicle system, detecting a state of the vehicle environment, and detecting a state of the power supply

In other embodiments of the first broad aspect, the detection apparatus is further operable to generate an indicator based on the detected operational state of the vehicle, and the power control apparatus is operable to control power to the computing device based on the indicator.

In other embodiments of the first broad aspect, the second power level is lower than the first power level. In other embodiments, at the second power level, the computing device is in an off state and, at the first power level, the computing device is in a fully functional state. In yet further embodiments, at the second power level the computing device is in a partially functional state. In yet further embodiments the computing device comprises a plurality of components; and at the second power level, at least one first component of the computing device is functional and at least one second component of the computing device is not functional. In some embodiments, the at least one first component comprises a wireless communication component and the at least one second component comprises a GPS component

In other embodiments of the first broad aspect, the computing device is controlled to a third power level when the vehicle is in a third operational state, and at the third power level the computing device is in a partially functional state. In some embodiments, at the third power level, at least one first component of the computing device is functional and at least one second component of the computing device is not functional.

In other embodiments of the first broad aspect, the computing device comprises a plurality of components; and wherein at least one component of the computing device is always powered.

In other embodiments of the first broad aspect, the detection apparatus is in wireless communication with the power control apparatus.

In other embodiments of the first broad aspect, the detection apparatus is in wireline communication with the power control apparatus

In other embodiments of the first broad aspect, the detection apparatus is integrated into the power control apparatus. In some embodiments, the power control apparatus comprises an electropneumatic switch.

A second broad aspect of the present invention seeks to provide an apparatus for controlling power to a computing device on a vehicle, the computing device powered from a local power supply. The apparatus includes means for detecting an operational state of a vehicle. The apparatus further includes means for controlling the power level of the computing device based upon the operational state of the vehicle, wherein the power level of the computing device is controlled to a first power level when the vehicle is in a first operational state and controlled to a second power level when the vehicle is in a second operational state.

A third broad aspect of the present invention seeks to provide a system for controlling power to a computing device on a vehicle, the computing device powered from a local power supply. The system includes a detection apparatus operable to detect an operational state of the vehicle and to transmit an indicator based on the operational state of the vehicle; the indicator being operable to cause the power control apparatus to control power to the computing device. In some embodiments, the system further includes the power control apparatus.

A fourth broad aspect of the present invention seeks to provide a system for controlling power to a computing device on a vehicle, the computing device powered from a local power supply. The system includes, a power control apparatus operable to receive an indicator that represents an operational state of the vehicle, and to control the power level of the computing device based upon the indicator; wherein the power level of the computing device is controlled to a first power level when the vehicle is in a first operational state and controlled to a second power level when the vehicle is in a second operational state.

### BRIEF DESCRIPTION OF THE DRAWINGS

Embodiments of the present invention are described with reference to the following figures, in which:

FIGS. 1A to 1H depict systems for controlling power to a computing device local to a vehicle according to various embodiments of the present invention, each Figure depicting alternative embodiments for a detection apparatus;

FIGS. 2A to 2G depict systems for controlling power to a computing device local to a vehicle according to various embodiments of the present invention, each Figure depicting alternative embodiments for controlling the power;

FIG. 3 depicts a method for controlling power to a computing device local to a vehicle according to an embodiment of the present invention; and

FIG. 4 depicts a non-limiting example of a tractor/trailer combination in which one embodiment of the present invention is implemented.

### DETAILED DESCRIPTION OF THE EMBODIMENTS

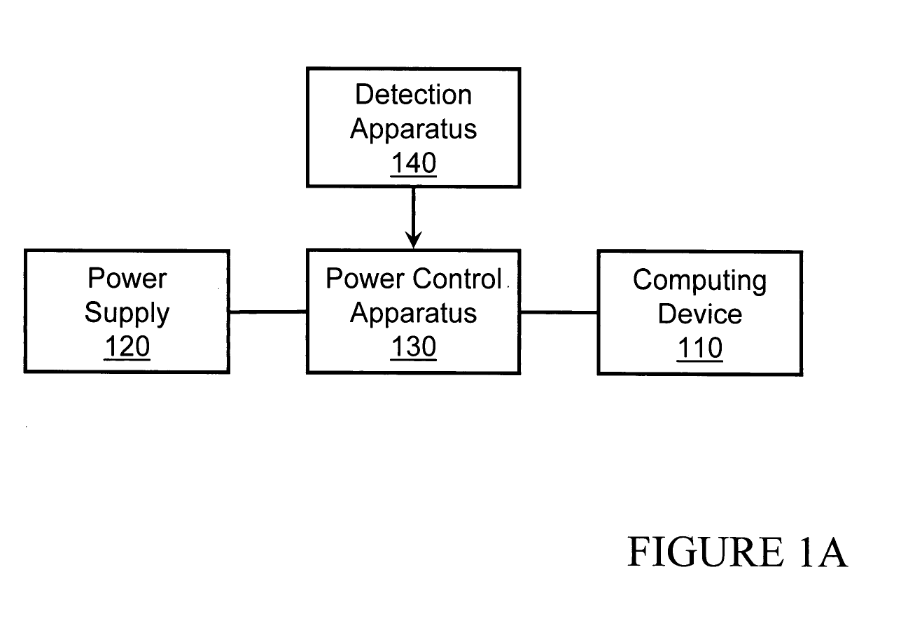

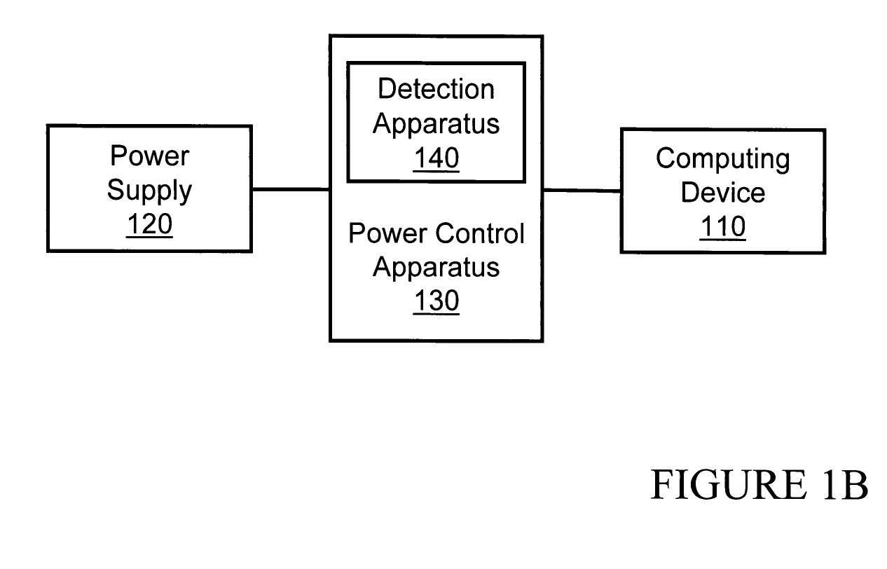

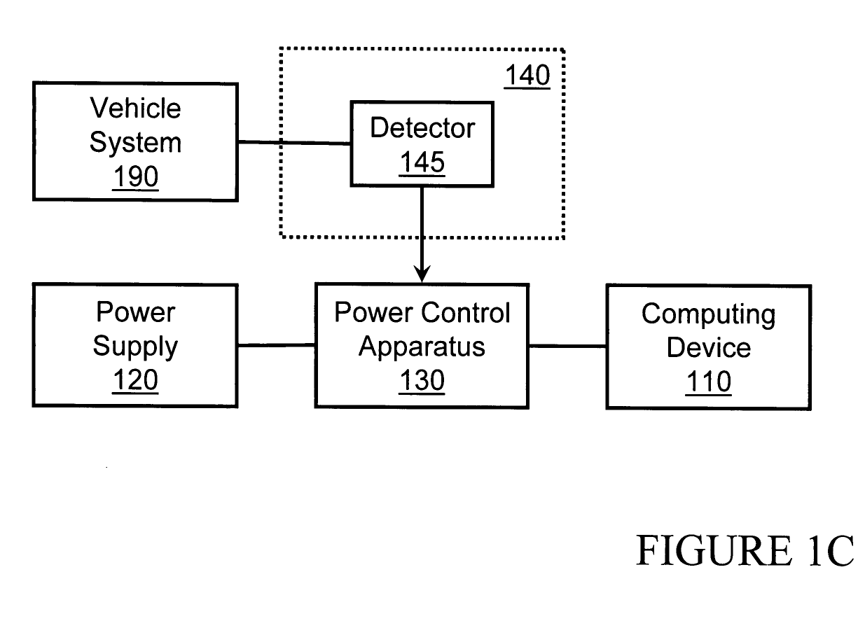

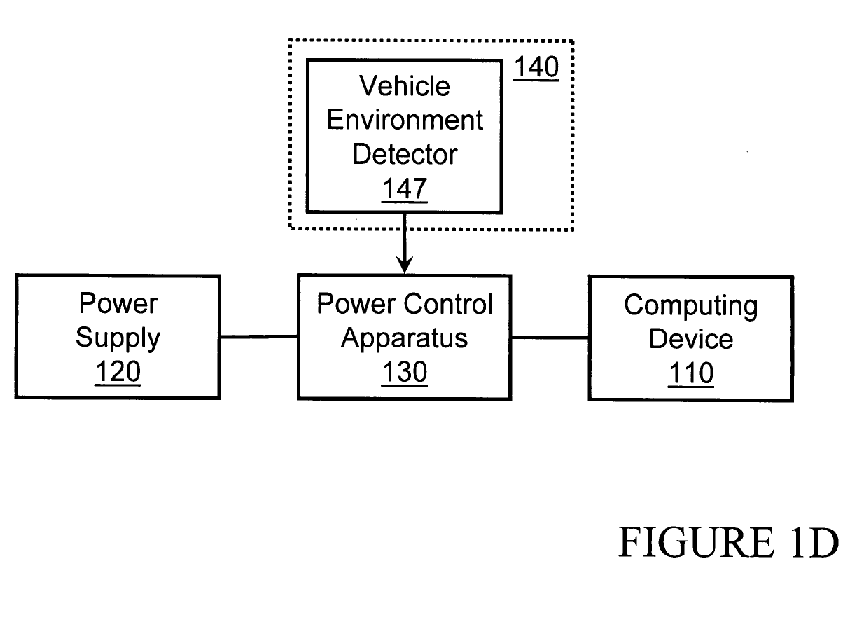

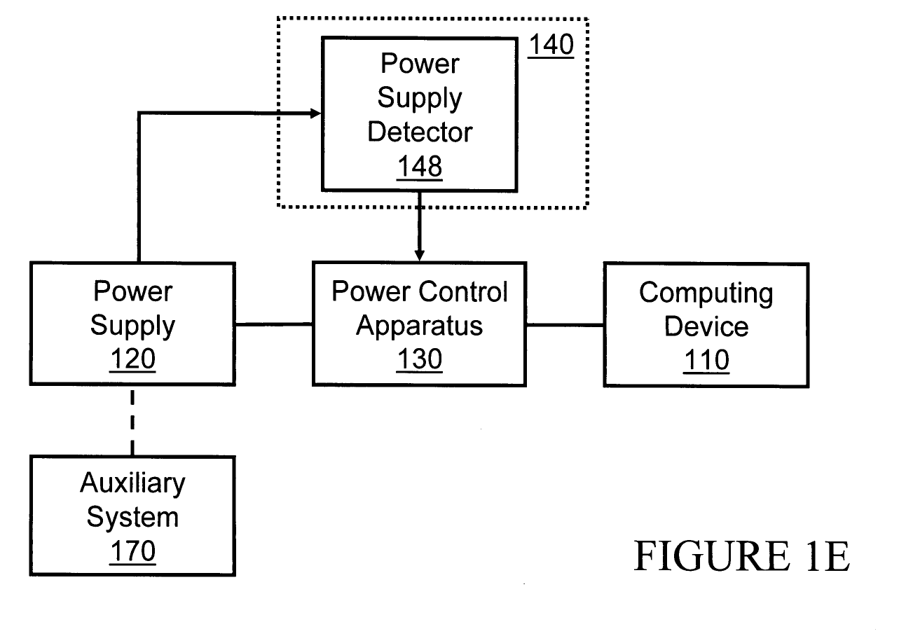

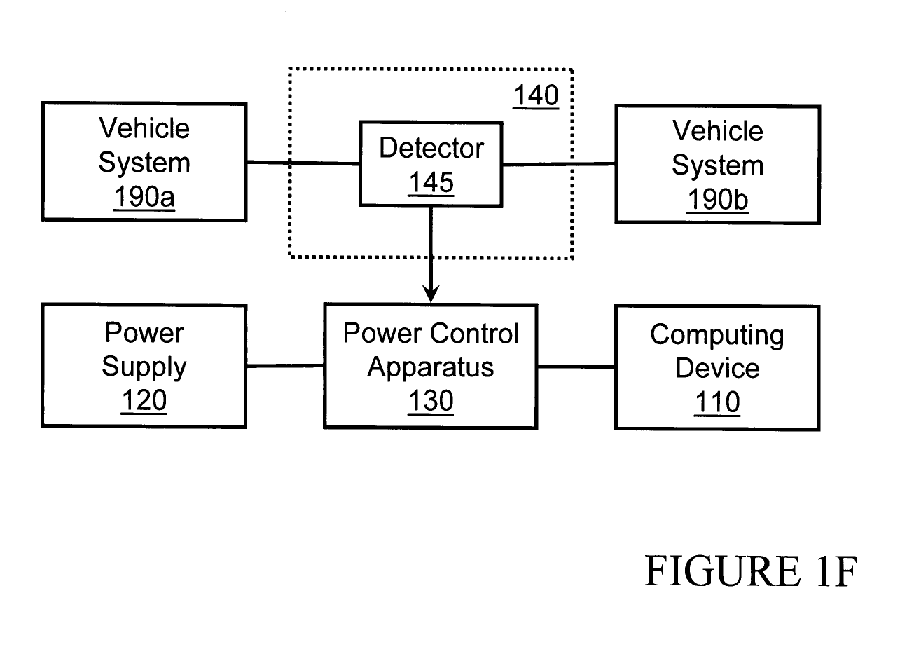

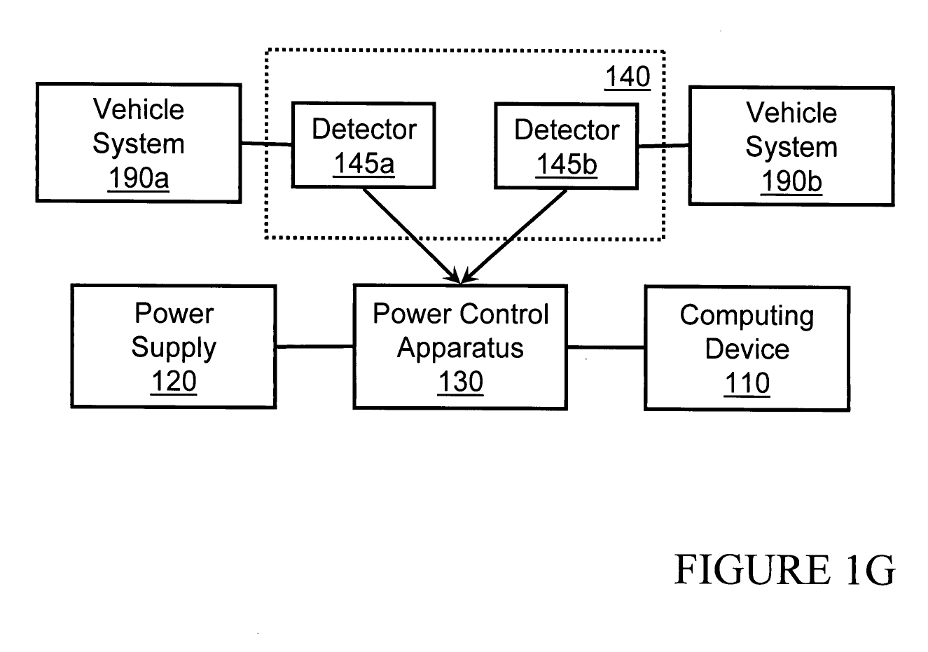

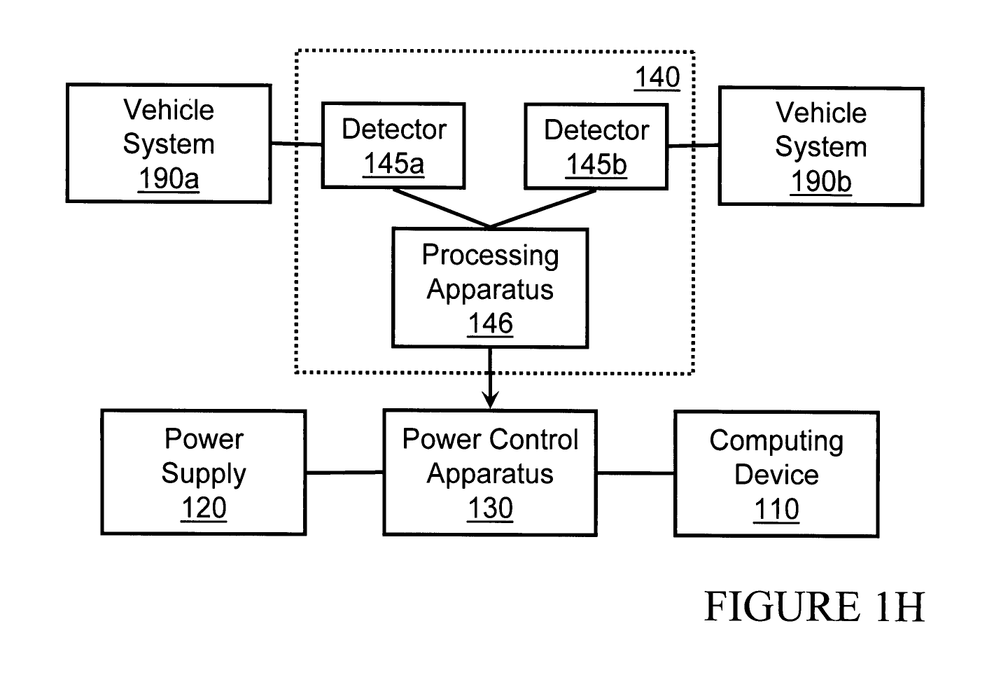

FIG. 1A depicts a system according to one embodiment of the present invention for controlling power to a computing device 110 which is powered by power supply 120. In general, the computing device 110 and power supply 120 will be local to a vehicle. The system comprises a power control apparatus 130 for controlling power from the power supply 120 to the computing device 110 and a detection apparatus 140 in communication with the power control apparatus 130. The detection apparatus 140 is operable to detect an operational state of the vehicle and, in response, to transmit a signal to the power control apparatus 130. The power control apparatus 130 is operable to receive the signal from the detection apparatus 140 and to control the power level of the computing device 110 based on the received signal. The vehicle may be any vehicle with at least one local power supply, and may include an automobile, a boat, an airplane, a tractor, a tractor/trailer combination, a trailer coupled to a tractor, or a trailer which is operable to be coupled to another vehicle. The type of vehicle in which the system of FIG. 1A is to be utilized is not meant to limit the scope of the present invention.

The computing device 110 may be any device that requires power and is local to the vehicle. The computing device 110 may be accessible to a user of the vehicle and/or may be accessible to a remote entity. In embodiments in which the computing device 110 is accessible to a remote entity, the computing device 110 may comprise a wireless communication component for wireless transmission of information to the remote entity or may be coupled to a wireless communication component. In some embodiments, the computing device 110 may comprise a global positioning system (GPS), a telematics apparatus, an on-board computer, a vehicle diagnostic apparatus, a driver log-in apparatus, a driver monitoring apparatus, a memory device, an environmental monitoring apparatus, a security apparatus or a combination thereof. Other examples of computing device 110 may occur to those of skill in the art and are within the scope of the present invention.

The power supply 120 may be any suitable battery or batteries, fuel cell, or any other source of power which can store power and supply power to the computing device 110. The power supply I 120 may be dedicated to supplying power to the computing device 110, but may also supply power to other systems within the vehicle. In some embodiments, the power supply 120 may be electrically coupled to a system that can charge the power supply 120, such as solar panels or a generator. In the non-limiting example in which the vehicle is a trailer, the power supply 120 could be local to the trailer or local to a tractor coupled to the trailer, but in electrical communication with the computing device 110 via a trailer/tractor coupling mechanism.

The detection apparatus 140 is operable to detect an operational state of the vehicle. In some embodiments, as depicted in FIG. 1A, the detection apparatus 140 is separate from the power control apparatus 130 and transmits a signal to the power control apparatus 130. The signal is used by the power control apparatus 130 to control power to the computing device 110. An alternative embodiment in FIG. 1B depicts a system similar to FIG. 1A with similar components depicted with similar numbers. In this embodiment, the detection apparatus 140 is integrated directly into the power control apparatus 130. Although non-limiting example embodiments of the present invention described herein below in detail are depicted with the detection apparatus 140 and the power control apparatus 130 being separate apparatuses, one skilled in the art should understand that these apparatuses could also be physically integrated or combined into a single apparatus.

It should be understood that the physical implementation of the detection apparatus 140 is not meant to limit the scope of the present invention. The detection apparatus 140 may be an electronic apparatus which electronically detects the operational state of the vehicle, a mechanical apparatus which mechanically detects the operational state of the vehicle or a combination thereof. The signal generated by the detection apparatus 140 may also be either an electronic signal and/or a mechanical response. In some embodiments, the signal generated by the detection apparatus 140 represents the operational state of the vehicle, however, in other embodiments, the signal may represent a change in the operational state of the vehicle.

Furthermore, in embodiments where the detection apparatus 140 is an apparatus that requires power to be operable, the detection apparatus 140 may draw the required power from the power supply 120. In further embodiments the detection apparatus 140 may draw power from any other suitable power supply.

Various embodiments for implementing the detection apparatus 140 will be described in detail herein below with reference to FIGS. 1C to 1H. It is noted that FIGS. 1C to 1H depict systems similar to FIG. 1A with similar components depicted with similar numbers. As depicted in FIG. 1C, in some embodiments, the detection apparatus 140 comprises a detector 145 coupled to a vehicle system 190, the detector 145 being operable to detect the operational state of vehicle system 190. In these embodiments, the detector 145 interfaces with the vehicle system 190 and produces a signal indicating the operational state of the vehicle system 190, which can indicate the operational state of the vehicle.

In a first non-limiting example, the vehicle system 190 can be a brake system. In this case, the detector 145 interfaces with the brake system and is operable to detect the operational state of the brake system. In a specific non-limiting example, the detector 145 can detect whether the operational state of the brake system is in an engaged state or a disengaged state. The detector 145 can be further operable to produce a signal to indicate the operational state of the brake system, which can correspond to the operational state of the vehicle. The signal could be sent when the detector 145 detects a change in the operational state of the vehicle system 190 or could be sent based upon another trigger. In some embodiments, the trigger could be based on a time interval occurring or a request from the power control apparatus 130.

In one specific non-limiting embodiment, the brake system can comprise an emergency brake system. In some embodiments, the emergency brake system comprises a pneumatic emergency brake system. In other embodiments, the emergency brake system comprises a hydraulic emergency brake system. Pneumatic and hydraulic emergency brake systems are engaged and disengaged through the application of pneumatic or hydraulic pressure, respectively. Hence, within these non-limiting embodiments, in order to detect the operational state of the vehicle, the detector 145 can be operable to detect the pressure of the emergency brake system. For example, if at a first pressure the emergency brakes are engaged, the vehicle is considered to be in a not-in-use state. And, if at a second pressure the emergency brakes are disengaged, the vehicle is considered to be in an in-use state. Accordingly, the detector 145 can detect the brake pressure and produce a corresponding signal to indicate whether the operational state of the vehicle is in a not-in-use state or an in-use state.

In another embodiment, the emergency brake system can comprise a frictional emergency brake system, such as, but not limited to, a drum brake or a high friction brake pad, well known to those of skill in the art. Within these non-limiting embodiments, the detector 145 can be operable to detect the operational state of the frictional emergency brake system by detecting the position of a component of the emergency brake system. Alternatively, the detector 145 may be operable to detect the mechanical pressure between one component of the frictional emergency brake system and another component of the frictional emergency brake system. Effectively, the detector 145 detects the operational state of the brake system, which can correspond to an operational state of the vehicle, and produces a corresponding signal.

In another non-limiting example, the vehicle system 190 comprises an engine system. In this case, the detector 145 interfaces with the engine system of the vehicle and is operable to detect the operational state of the engine system. In a specific non-limiting example, the detector 145 can detect whether the operational state of the engine system is in an on state or an off state. In this example, the detector 145 is further operable to produce a signal to indicate the operational state of the engine, which can correspond to the operational state of the vehicle.

In some non-limiting embodiments, the detector 145 detects the operational state of the engine system by detecting the state of an electrical subsystem of the engine system. In other non-limiting embodiments, the detector 145 detects the operational state of the engine system by detecting the temperature of the engine system. In further non-limiting embodiments, the detector 145 may detect the operational state of the engine system by detecting the noise level of the engine system. In other embodiments, the detector 145 may detect the operational state of the engine system by detecting the pressure within the engine system. Other types of detectors for detecting the operational state of the engine system will occur to those of skill in the art and are within the scope of the present invention. In any event, the detector 145 produces a corresponding signal to indicate whether the operational state of the engine system is in an on state or an off state, which can indicate whether the operational state of the vehicle is in an in-use state or a not-in-use state.

In another non-limiting example, the vehicle system 190 comprises an ignition system. In this case, the detector 145 interfaces with the ignition system and is operable to detect the operational state of the ignition system. In a specific non-limiting example, the detector 145 can detect when the operational state of the ignition system is in an engaged state or a disengaged state. The detector 145 can be further operable to produce a signal to indicate the operational state of the ignition system, which can correspond to the operational state of the vehicle.

In some non-limiting embodiments, the detector 145 detects the operational state of the ignition system by detecting the state of an electrical subsystem of the ignition system. In other embodiments, the detector 145 detects the operational state of the ignition system by detecting the presence of a key in the ignition key slot. In yet other embodiments, the detector 145 detects the operational state of the ignition system by detecting the position of an ignition key slot. Other types of detectors for detecting the operational state of the ignition system will occur to those of skill in the art and are within the scope of the present invention. In any event, the detector 145 produces a corresponding signal to indicate whether the operational state of the ignition system is in an engaged state or a disengaged state, which can indicate whether the operational state of the vehicle is in an in-use state or a not-in-use state.

In yet another non-limiting example, the vehicle system 190 comprises an exhaust system. In this case, the detector 145 interfaces with the exhaust system of the vehicle and is operable to detect the operational state of the exhaust system. In a specific non-limiting example, the detector 145 detects when the operational state of the exhaust system is an in-use state or a not-in-use state. The detector 145 can be further operable to produce a signal to indicate the operational state of the exhaust system, which can correspond to the operational state of the vehicle.

In some non-limiting embodiments, the detector 145 detects the operational state of the exhaust system by detecting the temperature of the exhaust system. In other embodiments, the detector 145 detects the operational state of the exhaust system by detecting the flow of engine exhaust through the exhaust system. In other embodiments, the detector 145 detects the operational state of the exhaust system by detecting the pressure within the exhaust system. Other types of detectors for detecting the operational state of the exhaust system will occur to those of skill in the art and are within the scope of the present invention. In any event, the detector 145 produces a corresponding signal to indicate whether the operational state of the exhaust system is in an in-use state or a not-in-use state, which can indicate whether the operational state of the vehicle is in an in-use state or a not-in-use state.

In another non-limiting example, the vehicle system 190 comprises a transmission system. In this case, the detector 145 interfaces with the transmission system of the vehicle and is operable to detect the operational state of the transmission system. In a specific non-limiting example, the detector 145 can detect whether the operational state of the transmission system is in an engaged state or a disengaged state. The detector 145 can be further operable to produce a signal to indicate the operational state of the transmission system, which can correspond to the operational state of the vehicle.

In some non-limiting embodiments, the detector 145 detects the operational state of the transmission system by detecting the state of the speedometer of the vehicle, the speedometer being generally coupled to the transmission system. In other embodiments, the detector 145 detects the operational state of the transmission system by detecting the movement of components of the transmission system. In other embodiments, the detector 145 detects the operational state of the transmission system by detecting the pressure within the transmission system. Other types of detectors for detecting the operational state of the transmission system will occur to those of skill in the art and are within the scope of the present invention. In any event, the detector 145 produces a signal to indicate whether the operational state of the transmission system is in an engaged state or a disengaged state, which can indicate whether the operational state of the vehicle is an in-use state or a not-in-use state.

In embodiments where the vehicle comprises a trailer or a tractor/trailer combination, the vehicle system 190 comprises a coupling system. In this case, the detector 145 interfaces with the coupling system and is operable to detect the operational state of the coupling system. In a specific non-limiting example, the detector 145 detects whether the operational state of the coupling system is in a coupled state or an uncoupled state. The detector 145 can be further operable to produce a signal to indicate the operational state of the coupling system, which can correspond to the operational state of the vehicle.

In some non-limiting embodiments, the detector 145 detects the operational state of the coupling system by detecting the position of a hitch, latch or other mechanical device within the coupling system. In further embodiments, the detector 145 detects the operational state of the coupling system by detecting the pressure within the coupling system. Other types of detectors for detecting the operational state of the coupling system will occur to those of skill in the art and are within the scope of the present invention. In any event, the detector 145 produces a corresponding signal to indicate whether the operational state of the coupling system is in a coupled state or an uncoupled state, which can indicate whether the operational state of the vehicle is in an in-use state and a not-in-use state.

In alternative embodiments, as depicted in FIG. 1D, the detection apparatus 140 comprises a vehicle environment detector 147 which is operable to detect the operational state of the vehicle by detecting the vehicle environment. Non-limiting examples of the vehicle environment detector 147 include: a motion detector for detecting the motion of the vehicle, a vibration detector for detecting vibration of the vehicle, a driver log-in module for monitoring access of the driver, a proximity detector for monitoring proximity to another vehicle (ex. a tractor to a trailer), or a presence detector for detecting the presence of a user in the driver's seat of the vehicle. Other types of vehicle environment detectors will occur to those of skill in the art and are within the scope of the present invention.

Non-limiting examples of motion detectors comprise sensing changes in position through a Global Positioning System or a mobile radio system, for example a 1× triangulation. Further non-limiting examples of motion detectors comprise a detector in communication with a drive shaft of the vehicle, a detector in communication with a drive axle of the vehicle, a detector in communication with the hub assembly of the vehicle, or a detector in communication with components associated with the hub assembly of the vehicle. However other types of motion detectors will occur to one of skill in the art and are within the scope of the present invention.

In alternative embodiments, as depicted in FIG. 1E, the detection apparatus 140 comprises a power supply detector 148 which is operable to detect the operational state of the vehicle by detecting the power level of the power supply 120. Non-limiting examples of the power supply detector 148 include: a voltmeter for detecting the voltage level of the power supply 120, and a power detector for detecting the power level of the power supply 120, or an ammeter to detect an activated charging system. Other types of power supply detectors will occur to those of skill in the art and are within the scope of the present invention.

In alternative embodiments, as depicted in FIG. 1E, the system may include at least one auxiliary system 170 which is powered by power supply 120. The auxiliary system 170 may be any vehicle system or component, including any auxiliary system that would benefit from having power available for an extended period of time. For example, if the vehicle comprises a trailer having a temperature control system, it may be advantageous to ensure that power to the temperature control system is available for an extended period of time if the trailer is parked or is stationary indefinitely. In further embodiments, the auxiliary system 170 may be one or more of an ignition system, a vehicle tracking system, an emergency monitoring system, a communications system, a vehicle diagnosis system, an electronic door lock system, a security system, or a water removal system in embodiments where the vehicle is a boat. Other potential vehicle systems or components will occur to those with skill in the art. In further embodiments, the power supply 120 will power a plurality of auxiliary systems 170.

In embodiments in which the power supply 120 supplies power to one or more auxiliary systems 170, it becomes more important that the power supply's 120 power does not get completely drained. In this case the power supply detector 148 of FIG. 1E is particularly useful.

As depicted in FIG. 1F, in some embodiments of the present invention, the detector 145 is operable to interface with a plurality of vehicle systems 190a, 190b. In these embodiments, the detector 145 is operable to detect the operational state of each of the vehicle systems 190a, 190b in order to detect the operational state of the vehicle. In some embodiments, the detector 145 is operable to produce a signal to indicate the operational state of the vehicle based upon the detected operational state of each of the vehicle systems 190a and 190b. In some embodiments, the detector 145 is operable to produce a signal to indicate the operational state of the vehicle based on the detected operational state of one of the vehicle systems 190a and 190b.

In other non-limiting embodiments of the system depicted in FIG. 1F, the detector 145 may be operable to interface with one or more of vehicle systems 190a, 190b, and detector 145 may be further combined with a different type of detector, for example, the vehicle environment detector 147 of FIG. 1D, or power supply detector 148 of FIG. 1E. For example, by receiving indications of the operational state of one or more of the vehicle systems 190a, 190b and by further receiving indications of the operational state of the vehicle environment or the operational state of the power supply 120, the detector 145 can detect the operational state of the vehicle. In some embodiments, the detector 145 may detect the operational state of the vehicle based on the operational state of one of the vehicle systems 190a, 190b, the operational state of the vehicle environment or the operational state of the power supply 120. However in further embodiments the detector 145 may combine information of the operational states of the various vehicle systems, the operational states of the vehicle environment and/or the operational state of the power supply level, and arrive at an enhanced understanding of the operational state of the vehicle

In order to understand how the detector 145 may combine information of the operational states of the various vehicle systems, the operational states of the vehicle environment and/or the operational state of the power supply level, and arrive at an enhanced understanding of the operational state of the vehicle, it is useful to categorize the various vehicle systems and detectors. For example, detection of the operational states of the engine system, the ignition system or the exhaust system may yield information on whether the vehicle is in an off state or an on state. Furthermore, if the detector 145 is a vibration detector, information gathered by the vibration detector may also yield information on whether the vehicle is in an off state or an on state. Similarly, detection of the operational states of the emergency brake system or the transmission system may yield information on whether the vehicle is in motion or not in motion. Furthermore, if the detector 145 is a motion detector, information gathered by the motion detector may also yield information on whether the vehicle is in motion or not in motion. In the same vein, detection of the operational state of the coupling system may yield information on whether the vehicle is in a coupled state or an uncoupled state. Furthermore if the detector 145 is a proximity detector, information gathered by the proximity detector may also yield information on whether the vehicle is in a coupled or uncoupled state. Finally, if the detector 145 is a presence detector or a login module, information gathered by the presence detector or the login module may yield information on the presence of a user in the driver's seat of the vehicle.

Hence, by combining information regarding the on/off state of the vehicle, information regarding the movement of the vehicle, information regarding the coupled state of the vehicle, information regarding the power level of the power supply 120, and/or information regarding the presence of a driver, the detector 145 may arrive at an enhanced understanding of the operational state of the vehicle. It should be understood that the detector 145 may utilize one or more of those categories of information to determine the operational state of the vehicle.

In one non-limiting example, the detector 145 may interface with a vehicle system 190a which yields information on whether the vehicle is moving or not moving. However, detector 145 may be further operable to detect the vehicle movement via the motion of the vehicle and may comprise a motion detector. Further, the detector 145 may further interface with a vehicle system 190b which yields information on whether the vehicle is in an on state or on off state. However, detector 145 may be further operable detect whether the vehicle is in an on state or an off state via the vibration of the vehicle and may comprise a vibration detector. In one specific non-limiting example, the vehicle system 190a is an emergency brake system and the vehicle system 190b is an engine system. In this case, the detector 145 interfaces with the emergency brake system and is operable to detect whether the operational state of the emergency brake system is in an engaged state or a disengaged state. The detector 145 further interfaces with the engine system and is further operable to detect whether the operational state of the engine system is in an on state or an off state. The detector 145 may be further operable to produce a signal responsive to the combined operational states of both vehicle systems 190a, 190b.

For instance, the detector 145 may detect that the emergency brake system is in an engaged state and further detect that the engine system is in an off state. In this case, the detector 145 may produce a signal indicating that the operational state of the vehicle is in a not-in-use state. Correspondingly, the detector 145 may detect that the emergency brake system is in a disengaged state and further detect that the engine system is in an on state. In this instance, the detector 145 may produce a signal indicating that the operational state of the vehicle is in an in-use state. In another case, the detector 145 may detect that the emergency brake system is in an engaged state and further detect that the engine system is in an on state. In this instance, the detector 145 may produce a signal indicating that the operational state of the vehicle is in a state intermediate the in-use state and the not-in-use on state.

In a further embodiment of the previous example, where the detector 145 comprises a vibration detector, by receiving indications of the operational state of an emergency brake system and by further receiving indications of the state of the vibration of the vehicle, the detector 145 can detect the operational state of the vehicle, similar to that described in the previous example.

In yet a further embodiment of the previous example, where the detector 145 comprises a motion detector, by receiving indications of the state of the motion of the vehicle, and by further receiving indications of the operational state of the engine system, the detector 145 can detect the operational state of the vehicle, similar to that described in the previous example.

In another non-limiting example, the detector 145 may interface with a vehicle system 190a which yields information on whether the vehicle is coupled or not coupled. The detector 145 may be further operable detect whether the vehicle is coupled or uncoupled via the proximity of the vehicle to another vehicle, and may comprise a proximity detector. Further, the detector 145 may further interface with a vehicle system 190b which yields information on whether the vehicle is in an in-use state or a not-in-use state. The detector 145 may be further operable to detect whether the vehicle is in an in-use state or a not-in-use state via the vibration of the vehicle and may comprise a vibration detector. In a specific non-limiting example, the vehicle system 190a comprises a coupling system and vehicle system 190b comprises an engine system. In this case, the detector 145 interfaces with the coupling system and is operable to detect whether the operational state of the coupling system is in a coupled state or an uncoupled state. The detector 145 further interfaces with the engine system and is further operable to detect whether the operational state of the engine system is in an on state or an off state. The detector 145 may be further operable to produce a signal responsive to the operational state of both vehicle systems 190a, 190b.

For instance, the detector 145 may detect that the coupling system is in an uncoupled state and may further detect that the engine system is in an off state. In this instance, the detector 145 may produce a signal indicating that the operational state of the vehicle is in a not-in-use state. Correspondingly, the detector 145 may detect that the coupling system is in a coupled state and further detect that the engine system is in an on state. In this instance, the detector 145 may produce a signal indicating that the operational state of the vehicle is an in-use state. In another case, the detector 145 may detect that the coupling system is in a coupled state and further detect that the engine system is in an off state. In this instance, the detector 145 may produce a signal indicating that the operational state of the vehicle is in a state intermediate to an in-use state and a not-in-use state.

In another non-limiting example, the detector 145 interfaces with a vehicle system 190a which yields information on whether the vehicle is coupled or not coupled. The detector 145 may be further operable detect whether the vehicle is coupled or uncoupled via the proximity of the vehicle to another vehicle, and may comprise a proximity detector. Further, the detector 145 may further interface with a vehicle system 190b which yields information on whether the vehicle is moving or not moving. The detector 145 may be further operable to detect whether the vehicle is moving or not moving via the motion of the vehicle and may comprise a motion detector. In a specific non-limiting example, the vehicle system 190a is a coupling system and the vehicle system 190b is an emergency brake system. In this instance, the detector 145 interfaces with the coupling system and is operable to detect whether the operational state of the coupling system is in a coupled state or an uncoupled state. The detector 145 can further interface with the emergency brake system and be further operable to detect whether the operational state of the emergency brake system is in an engaged state or a disengaged state. The detector 145 may be further operable to produce a signal responsive to the operational state of both vehicle systems 190a, 190b.

For instance, the detector 145 may detect that the coupling system is in an uncoupled state and further detect that the emergency brake system is in an engaged state. In this instance, the detector 145 may produce a signal indicating that the operational state of the vehicle is in a not-in-use state. Correspondingly, the detector 145 may detect that the coupling system is in a coupled state and further detect that the emergency brake system is in a disengaged state. In this instance, the detector 145 may produce a signal indicating that the operational state of the vehicle is in an in-use state. In another case, the detector 145 may detect that the coupling system is in a coupled state and further detect that the emergency brake system is in an engaged state. In this instance, the detector 145 may produce a signal indicating that the operational state of the vehicle is in a state intermediate to an in-use state and a not-in-use state.

In each of the previous examples, the detector 145 may also comprise a presence detector. In a non-limiting example, information regarding the presence of a driver in the vehicle may be combined with information regarding the on or off state of the vehicle to gain an enhanced understanding of the operational state of the vehicle. In a non-limiting example, the detector 145 may detect that no driver is present in the vehicle and further detect that the vehicle is in an off state. In this instance, the detector 145 may produce a signal indicating that the operational state of the vehicle is in a not-in-use state. Correspondingly, the detector 145 may detect that a driver is present in the vehicle and further detect that the vehicle is in an on state. In this instance, the detector 145 may produce a signal indicating that the operational state of the vehicle is in an in-use state. Furthermore, the detector 145 may detect that a driver is present in the vehicle and further detect that the vehicle is in an off state. In this instance, the detector 145 may produce a signal indicating that the operational state of the vehicle is in a state intermediate an in-use state and a not-in-use state.

In further embodiments, the detector 145 may combine information regarding the presence of a driver with information regarding the movement of a vehicle, to gain an enhanced understanding of the operational state of the vehicle. In yet further embodiments, the detector 145 may combine information regarding the presence of a driver with information regarding the coupled state of a vehicle, to gain an enhanced understanding of the operational state of the vehicle.

FIGS. 1G and 1H depict alternative embodiments to the detection apparatus 140 depicted in FIG. 1F. In FIG. 1G, the detection apparatus 140 comprises a plurality of detectors 145a, 145b, each of which are operable to interface with one or more of the plurality of vehicle systems 190a, 190b. In this embodiment, each of the detectors 145a, 145b transmits a signal to the power control apparatus 130 indicating the state of the one or more vehicle systems 190a, 190b in which it interfaces. The power control apparatus 130 utilizes the information received from the plurality of detectors 145a, 145b to determine the operational state of the vehicle and control the power to the computing device 110 in response. In this case, similar to the examples described above with reference to FIG. 1F, the power control apparatus 130 could utilize the information received from each detector 145a, 145b as independent indications of the operational state of the vehicle or alternatively could combine the information from the plurality of detectors 145a, 145b to make a conclusion on the operational state of the vehicle. In FIG. 1H, the detection apparatus 140 comprises a plurality of detectors 145a, 145b and a processing apparatus 146. The processing apparatus 146 is operable to analyse the signals received from the detectors 145a, 145b and to generate a signal concluding the operational state of the vehicle based upon the received signals. In this embodiment, the processing apparatus 146 could utilize the information received from each detector 145a, 145b as independent indications of the operational state of the vehicle or alternatively could combine the information from the plurality of detectors 145a, 145b to make a conclusion on the operational state of the vehicle. The processing apparatus 146 is further operable to transmit a signal to the power control apparatus 130 indicating the operational state of the vehicle. It should be understood that the power control apparatus 130 could be combined with either or both of the detectors 145a, 145b and/or the processing apparatus 146.

Returning briefly to the vehicle environment detector 147 of FIG. 1D and the power supply detector 148 of FIG. 1E, in some embodiments of the present invention, either of these detectors could further be implemented within one of the systems of FIGS. 1C, 1F-1H, in which one or more of the detectors 145, 145a, 145b interface with the vehicle systems 190, 190a, 190b respectively. In this case, either the power control apparatus 130 or the processing apparatus 146 of FIG. 1H receive the signals from the power supply detector 148 and at least one of the other detectors 145, 145a, 145b and determines the operational state of the vehicle based upon these received signals. For example, by receiving indications of changes in one or more of the vehicle systems 190 and receiving indications of changes in power supply 120 of the vehicle, the power control apparatus 130 or the processing apparatus 146 can detect the operational state of the vehicle. In other embodiments of the present invention, the power supply detector 148 could further be implemented within the system of FIGS. 1D which includes the vehicle environment detector 147. In this case, the power control apparatus 130 or the processing apparatus 146 receives the signals from the power supply detector 148 and the vehicle environment detector 147 and determines the operational state of the vehicle based upon these received signals. For example, by receiving indications of changes in the vehicle environment and receiving indications of changes in power supply 120 of the vehicle, the power control apparatus 130 or the processing apparatus 146 can detect changes in the operational state of the vehicle.

Returning now to FIG. 1A, the power control apparatus 130 is operable to receive the signal indicating the operational state of the vehicle from the detection apparatus 140 and, in response, control the power level to the computing device 110 accordingly. The power may be controlled between a first power level and a second power level. For example, the power may be controlled between a first power level at which the computing device 110 is effectively on and a second I power level at which the computing device 110 is effectively off. In further embodiments, the power may also be controlled to one or more other power levels, intermediate the first power level and the second power level. In a non-limiting example, at the first power level, all features of the computing device 110 may be fully functional. At the second power level, the computing device 110 may have no functionality. At a third power level, the computing device 110 may have an intermediate level of functionality. At this intermediate level of functionality, some components of the computing device 110 may be on while other components are off and/or some components could have a lower power and a corresponding reduced level of functionality.

In yet further embodiments, the power control apparatus 130 may control the power to one of a plurality of intermediate power levels intermediate the first and second power levels, such that at each intermediate power level, different levels of functionality of the computing device 110 may be enabled.

In one embodiment, when the power control apparatus 130 receives a signal indicating that the operational state of the vehicle is in-use, the power control apparatus 130 controls the power level to the computing device 110 to a first power level, such that the computing device 110 is fully on and thus fully functional. Correspondingly, when the power control apparatus 130 receives a signal indicating that the operational state of the vehicle is not-in-use, the power control apparatus 130 controls the power level to the computing device 110 to a second power level, such that the computing device 110 is fully off. In a non-limiting example, the detection apparatus 140 will continue to monitor the operational state of the vehicle and, if the operational state of the vehicle changes, the detection apparatus 140 sends a signal to the power control apparatus 130 which, in response, controls power to the computing device 110.

In an alternative embodiment, the detection apparatus 140 will monitor the operational state of the vehicle on a continuous or periodic basis and, if the operational state of the vehicle changes, the detection apparatus 140 sends a signal to the power control apparatus 130 which, in response, controls power to the computing device 110. In yet another alternative embodiment, the detection apparatus 140 may monitor the operational state of the vehicle upon receipt of a trigger signal from another component of the system, including, but not limited to, the power control apparatus 130. In some embodiments, the detection apparatus 140 may send a signal to the power control apparatus 130 even if no change in the operational state is detected.

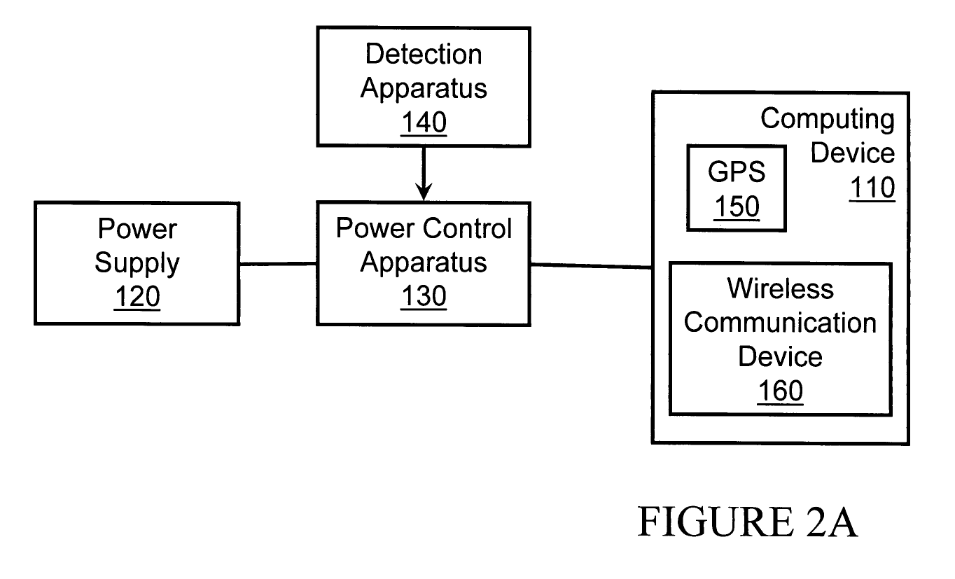

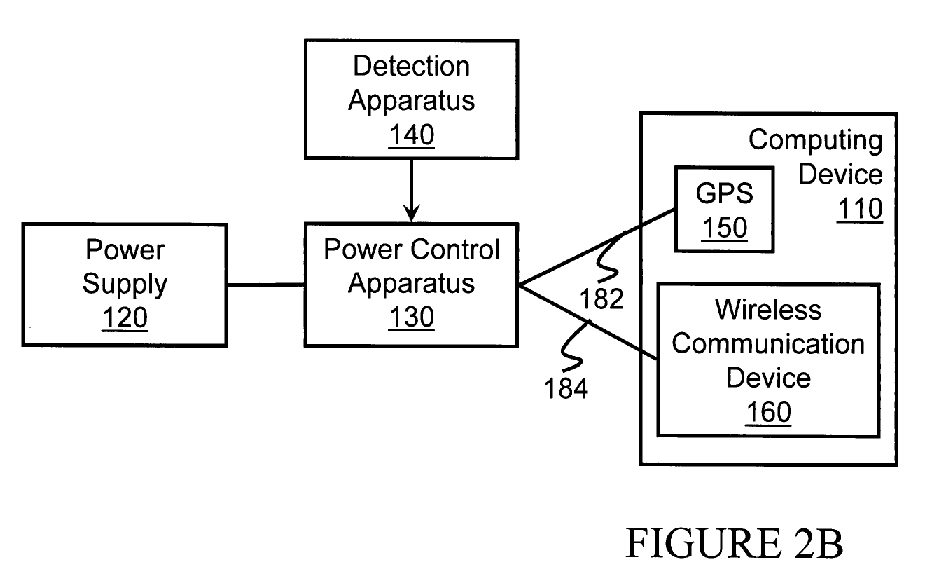

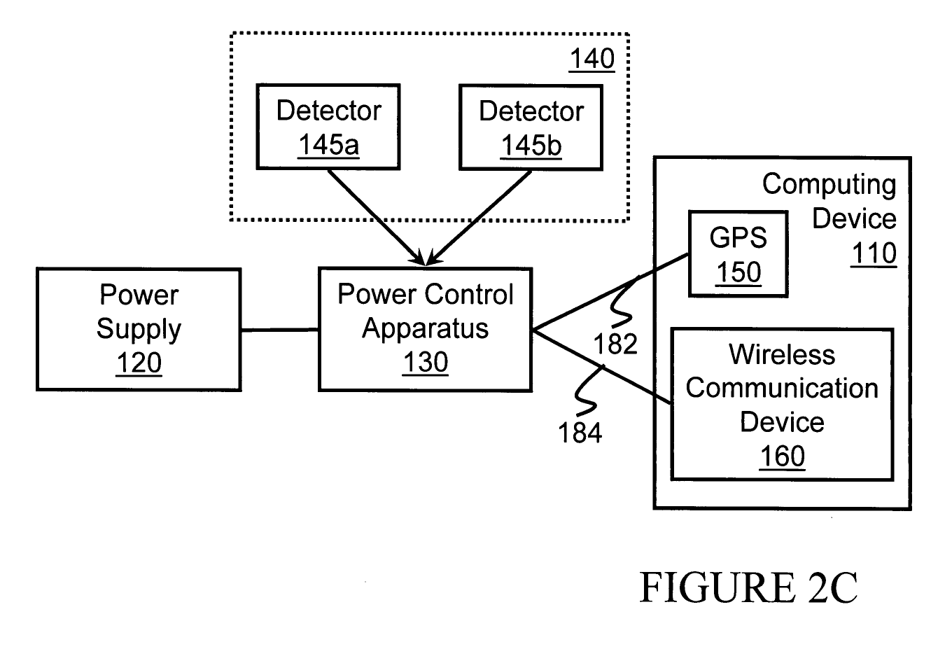

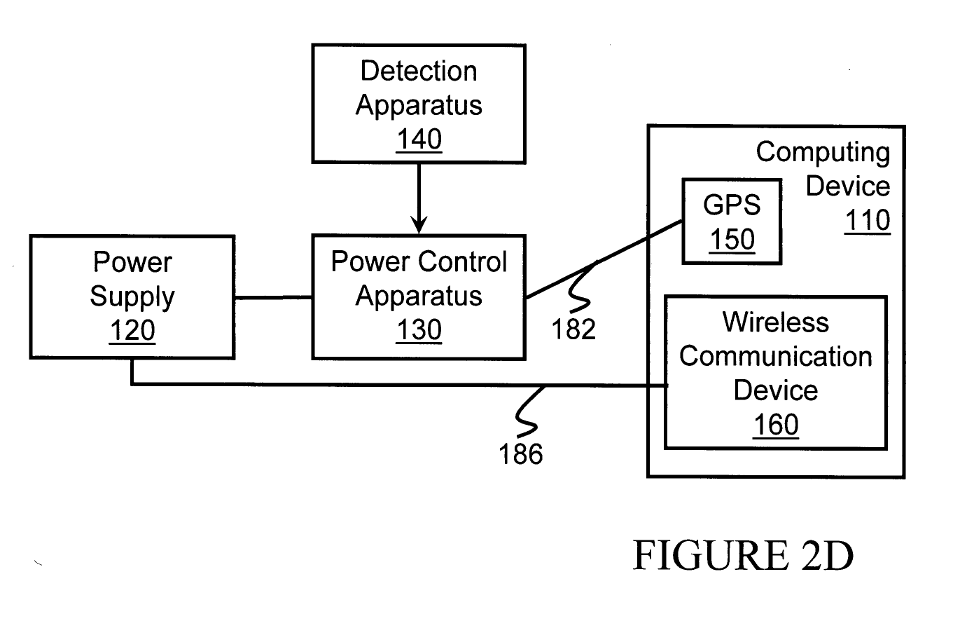

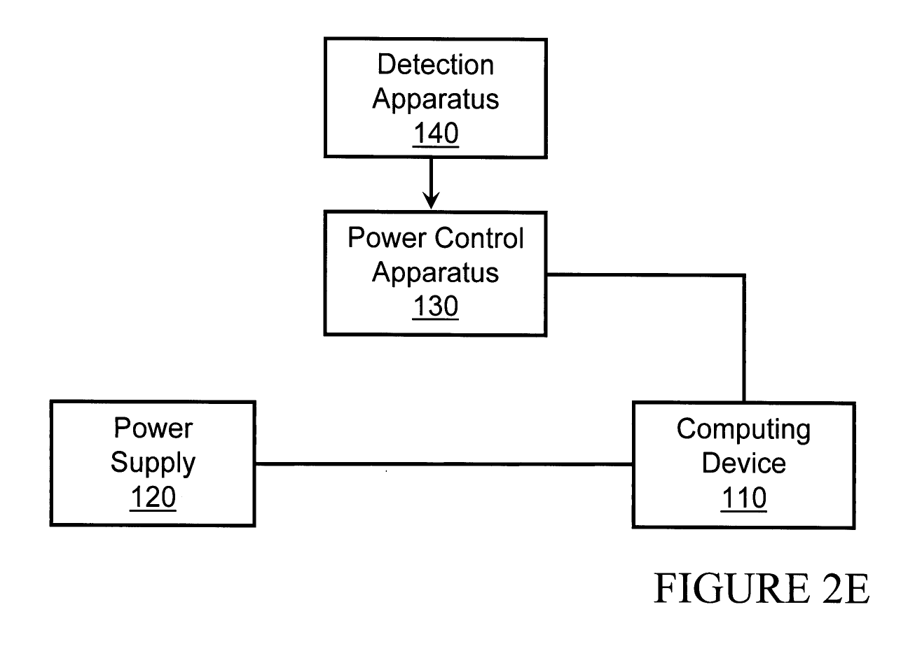

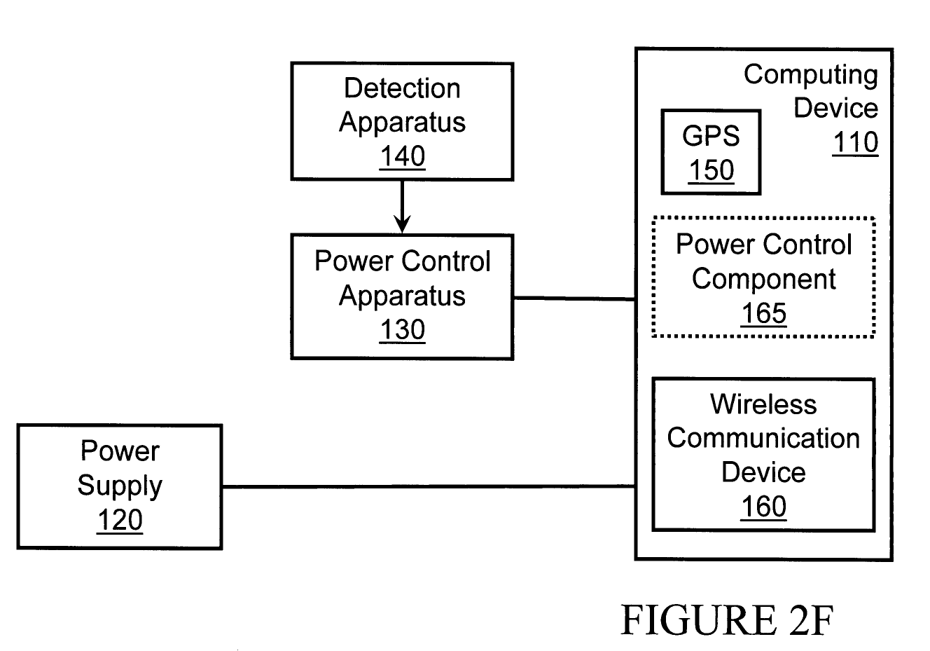

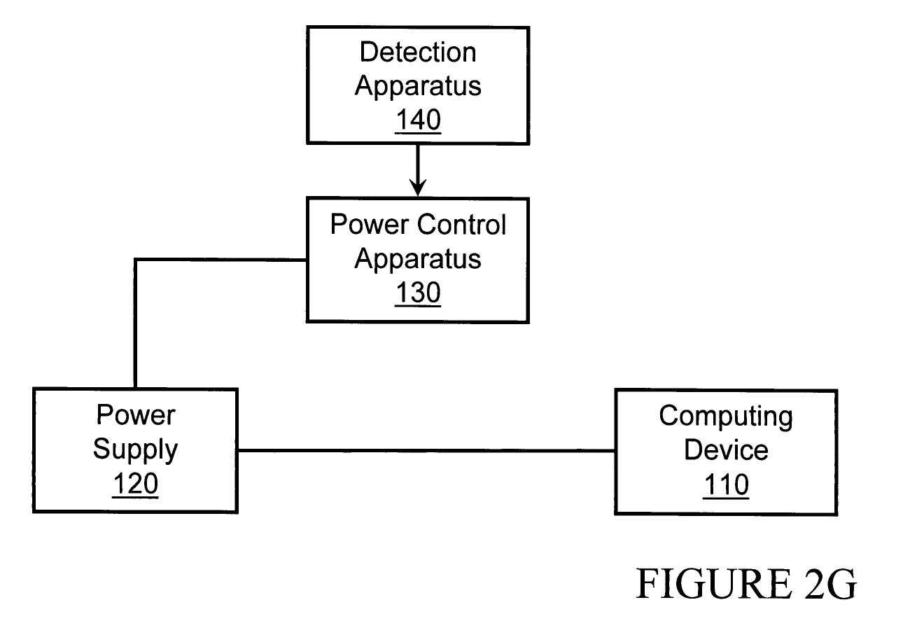

Various embodiments for illustrating the communication between the detection apparatus 140, the power control apparatus 130 and the computing device 110 will be described in detail herein below with reference to FIGS. 2A to 2G. It is noted that FIGS. 2A to 2G depict systems similar to FIG. 1A with similar components depicted with similar numbers.

In a non-limiting example, FIG. 2A depicts a system where the computing device 110 includes a Global Positioning System (GPS) 150, and a wireless communications device 160. In some embodiments the computing device 110 may also include a memory (not shown). In one embodiment, the computing device 110 is a telematics device. The telematics device may be on a vehicle, for example mounted to a vehicle, to monitor the position of the vehicle via the GPS 150 and communicate the position of the vehicle to a remote monitoring entity via the wireless communication device 160. Such a telematics device may also be operable to monitor other vehicle information and communicate this information to the remote monitoring entity via wireless communication device 160. Although described for the computing device 110 comprising the GPS 150 and the wireless communication 160, it should be understood that the below described examples apply to other embodiments in which the computing device 110 comprises a plurality of other types of components.

In one embodiment, when the detection apparatus 140 detects that the operational state of the vehicle is in-use, the power control apparatus 130 controls power to the computing device 110 to a first power level. At this first power level, the computing device 110 is fully functional and both the GPS 150 and the wireless communications device 160 are powered. Similarly, when the detection apparatus 140 detects that the operational state of the vehicle is not-in-use, power control apparatus 130 controls power to the computing device 110 to a second power level. At the second power level, the computing device 110 is fully off and neither the GPS 150 nor the wireless communications device 160 is powered. However, when the detection apparatus 140 detects that the operational state of the vehicle is at an intermediate level, the power control apparatus 130 controls power to the computing device 110 to a third power level. At the third power level the computing device 110 is partially functional and only one of the GPS 150 and the wireless communications device 160 are powered. In a specific non-limiting embodiment, at the third power level, the GPS 150 is not powered while the wireless communications device 160 is powered. In this manner the GPS 150 is turned off while still allowing a remote entity to wirelessly communicate with the computing device 110 via the wireless communications device 160 and, for example, download data from the memory, such as the last saved position before the GPS 150 was disabled.

In an alternative embodiment, the detection apparatus 140 may detect that the operational state of the vehicle is at another intermediate level, and the power control apparatus 130 controls power to the computing device 110 to a fourth power level. At the fourth power level, the computing device 110 is partially functional and only one of the GPS 150 and wireless communications device 160 are powered, while the other is powered intermittently or at a reduced level of functionality.

In a non-limiting example, the detection apparatus 140 may detect that the vehicle is parked or stationary and send a signal to the power control apparatus 130, which then controls power to the fourth power level. At this fourth power level, the computing device 110 may be in a sleep mode in which GPS readings are taken less frequently and the wireless communications device 160 is fully functional. In yet another embodiment, the detection apparatus 140 may then detect that the vehicle is parked or is stationary indefinitely and send a signal to the power control apparatus 130 which then controls power to the computing device 110 to the third power level, such that GPS unit 150 is completely off, however the wireless communications device 160 remains functional. In this manner the GPS 150 may be turned off while still allowing a remote entity to wirelessly communicate with the computing device 110 and, for example, download data from the memory, such as the last saved position before the GPS 150 was disabled.

Though the operational states of the vehicle which cause the power control apparatus 130 to control the power between the various power levels have been defined with respect to the specific example, other operational states of the vehicle that correspond to other power levels will occur to those of skill in the art.

In an alternative embodiment, as depicted in FIG. 2B, the power control apparatus 130 may control power to the computing device 110 via both a first electrical connection 182 and a second electrical connection 184. Within this embodiment, each of the electrical connections 182, 184 may be used to control power to specific components of the computing device 110. In one non-limiting example, the first electrical connection 182 may be used to control power to the GPS 150, while the second electrical connection 184 may be used to control power to the wireless communications device 160. In further embodiments, further electrical connections between the power control apparatus 130 and the computing device 110 may be present to control power to further components of the computing device 110. Each electrical connection may control a single component or multiple components. In a non-limiting example, either the first electrical connection 182 or the second electrical connection 184 may also be used to control power to the memory (not shown) of the computing device 110.

In yet another embodiment, in the system depicted in FIG. 2C, the detection apparatus 140 includes a plurality of detectors 145a and 145b, but is otherwise similar to the system depicted in FIG. 2B. In some embodiments, a change in operational state of a first vehicle system detected by one of the detectors 145a, 145b may cause the power control apparatus 130 to control power to the GPS 150 via the first electrical connection 182. Similarly the operational state of a second vehicle system as detected by the other of the detectors 145a, 145b may cause the power control apparatus 130 to control power to the wireless communications device 160 via the second electrical connection 184. In this manner, changes in operational state of specific vehicle systems may directly lead to the control of power to specific components of computing device 110. In further embodiments one or both of the detectors 145a, 145b may comprise a vehicle environment detector, similar to the vehicle environment detector 147 of FIG. 1D, and the operational state of the vehicle environment may directly lead to the control of power to specific components of the computing device 110. Similarly, in yet further embodiments, one of the detectors 145a, 145b may comprise a power supply detector, similar to the power supply detector 148 of FIG. 1E, and the operational state of the power supply 120 may directly lead to the control of power to specific components of the computing device 110.

In yet other embodiments, as depicted in FIG. 2D, a third electrical connection 186 may bypass power control apparatus 130 entirely and directly connect the power supply 120 with at least one component of the computing device 110. Within these embodiments, the at least one component of the computing device 110 which are directly connected to the power supply 120 via the third electrical connection 186 is in an always powered state. In a non-limiting example, the power supply 120 may be directly connected to the wireless communication device 160 within the computing device 110, such that wireless communication device 160 is always powered. Hence, a remote entity monitoring the computing device 110 is in constant communication with the computing device 110, while the power control apparatus 130 can control power to the GPS 150 and other components of the computing device 110.

In yet another alternative embodiment, depicted in FIG. 2E, the computing device 110 is in direct electrical connection with the power supply 120, and the computing device 110 is further operable to receive power control signals from the power control apparatus 130. In response to receiving these power control signals, the computing device 110 controls power to its various components. In one embodiment, the components of the computing device 110 may be operable to receive power control signals from the power control apparatus 130. In other embodiments, as depicted in FIG. 2F. the computing device 110 may include a power control component 165 operable to receive the power control signal from the power control apparatus 130 and further operable to control power to one or more components of the computing device 110, such as the GPS 150 and the wireless communications device 160.

In yet another embodiment, as depicted in FIG. 2G, the computing device 110 is in direct electrical connection with the power supply 120, and the power supply 120 is further operable to receive power control signals from the power control apparatus 130. In response to receiving these power control signals, the power supply 120 controls power to the computing device 110.

Further embodiments of the systems depicted in FIGS. 1A though 1H and FIGS. 2A through 2G may include a plurality of computing devices 110. Within some embodiments, power levels to the plurality of computing devices 110 may be controlled via at least one detection apparatus 140 in communication with at least one power control apparatus 130. However, other embodiments may include a plurality of detection apparatus 140 and/or a plurality of power control apparatus 130.

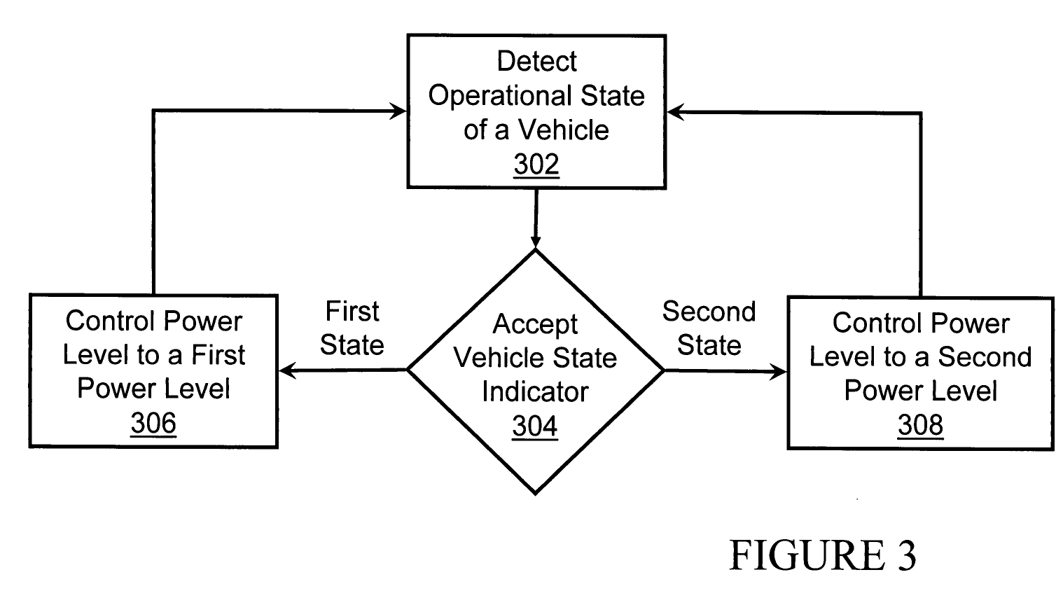

A method for controlling power to a computing device, according to an embodiment of the present invention, will now be described with reference to FIG. 3. In order to assist in the explanation of the method, it will be assumed that the method of FIG. 3 is operated using the system of FIG. 1A. Further, it is to be understood that the method of FIG. 3 may be operated using any of the systems depicted in FIGS. 1A-1H, 2A-2G. Furthermore, the following discussion of the method of FIG. 3 will lead to a further understanding of the system of FIGS. 1A-1H, 2A-2G and its various components. It should be understood that the steps in the method of FIG. 3 need not be performed in the sequence shown. Further, it is to be understood that the system of FIG. 1A and/or the method of FIG. 3 can be varied, and need not work as discussed herein in conjunction with each other, and that such variations are within the scope of the present invention.

By way of illustration only, the method of FIG. 3 will be described, when appropriate, using the non-limiting example of the method being executable within the detection apparatus 140 and the power control apparatus 130. At step 302, an operational state of a vehicle is detected. The state may comprise any operational state for which a corresponding power level to the computing device 110 is desired. For example, if the operational state of the vehicle is in-use, it may be desired that the power level to the computing device 110 be controlled to a first power level, such as a maximum power level. In this case, the computing device 110 is fully functional. If the operational state of the vehicle is not-in-use, it may be desired that the power level to the computing device 110 be controlled to a second power level, such as a minimum power level. In this case, the computing device is off or has a lower level of functionality.

As described above in detail, there are numerous indications of the operational state of a vehicle that can be detected. In particular, as described above, there are various embodiments of the present invention that allow for the detection of the operational state of the vehicle being in-use or not-in-use. Further, there are alternative embodiments of the present invention, as described above, in which an intermediary level of operation can be detected. In this case, the operational state of the vehicle may require that the power to the computing device 110 be controlled to a third power level. This third power level could be a power level intermediate to the first power level and the second power level or a selective powering of a subset of the components within the computing device 110 as described above.

At step 304, the operational state of the vehicle is accepted and a decision is made to control the power level to the computing device 110. If the vehicle is in a first operational state, the power level to the computing device 110 is controlled to a first power level at step 306. If the vehicle is in a second operational state, the power level to the computing device 110 is controlled to a second power level at step 308. Though not depicted, it is understood that there may be a plurality of operational states of the vehicle and a corresponding plurality of power levels to the computing device 110. Hence, if the vehicle is in a third operational state, the power level to the computing device 110 can be controlled to a third power level. Examples of embodiments where control to at least three power levels is desired have been described above, and are within the scope of the method of FIG. 3.

It is also understood that steps 304, 306 and 308 may be executable within a plurality of detection apparatus 140 and within a plurality of power control apparatus 130. For example, in cases where computing device 110 has more than one power input for powering different components of computing device 110, there may be one or more power control apparatus 130 in communication with one or more detection apparatus 140.

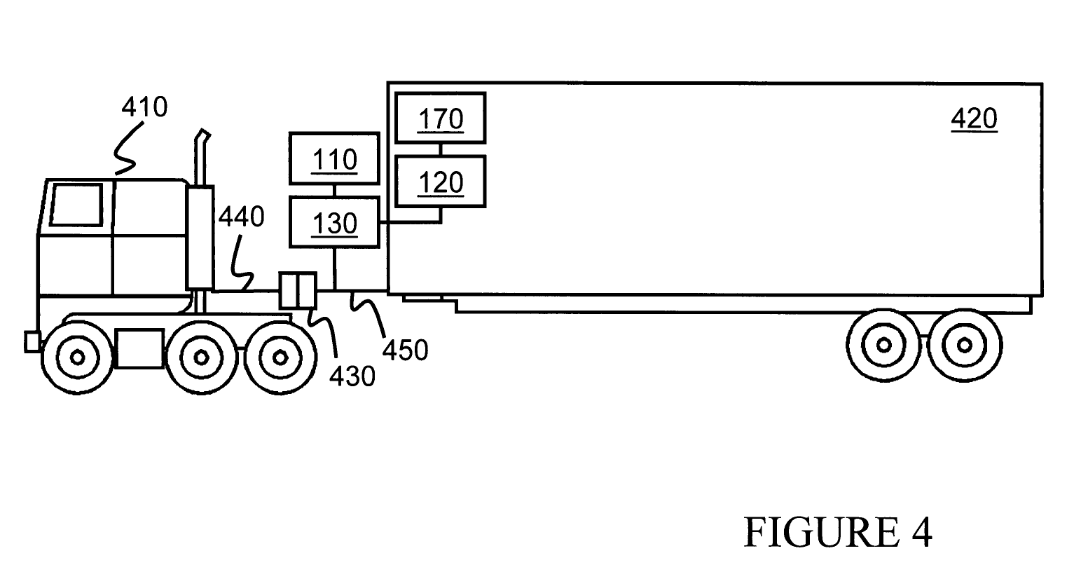

By way of illustration only, a non-limiting example of the application of the method of FIG. 3, executable within the system of FIG. 1B, will now be described with reference to FIG. 4. In this example, a tractor 410 is coupled to a trailer 420 via a coupling mechanism 430. It should be understood that FIG. 4 is a logical depiction of a non-limiting example of a tractor/trailer combination and, in a typical physical implementation, a portion of the tractor 410 would be underneath a portion of the trailer 420 when coupled together.

As depicted in FIG. 4, the coupling mechanism 430 is connected to the tractor 410 via tractor coupling line 440 and further connected to the trailer 430 via trailer coupling line 450. The coupling mechanism 430 may act to mechanically couple the tractor 410 to the trailer 420, allowing the tractor 420 to tow the trailer 420 and to couple systems of the tractor 410 to systems of the trailer 420. The coupling mechanism 430 may comprise a single coupling mechanism or a plurality of coupling mechanisms. As is well known to those of skill in the art, a common coupling mechanism for coupling a trailer to a tractor may comprise: a pivotal hitch where the main force of the tractor on the trailer is focused in the towing process; an electrical connector which allows the brake lights and running lights on a trailer to be operated from the tractor; and pneumatic connectors to connect the air brake systems of the tractor to the pneumatic brake systems of the trailer, including both the standard braking mechanism and the emergency braking mechanism. Pneumatic brake systems may include anti-locking brake systems (ABS) and associated connectors. Not all trailers are equipped with pneumatic brakes and may alternatively include hydraulic brakes or a mechanical or electrical anti-locking brake system (ABS). In these instances, the coupling mechanism 430 may include a suitable coupling mechanism for the corresponding braking system. Other types of connections may occur to those of skill in the art and are within the scope of the present invention.

The coupling mechanism 430 may also include a tractor portion and a trailer portion which are attached respectively to the tractor coupling line 440 and the trailer coupling line 450 respectively. Each portion is enabled to interface with the other portion such that the two portions succeed in coupling the trailer and tractor systems together, as well as providing a mechanical coupling between the trailer 420 and tractor 410.

Both the tractor coupling line 440 and the trailer coupling line 450 may include a plurality of coupling lines. For example, continuing with the example above, the tractor coupling line 440 and the trailer coupling line 450 may include electrical lines, a pneumatic brake line, a pneumatic emergency brake line, and a mechanical coupling line, each interfacing with the corresponding system on the tractor or trailer via coupling mechanism 430.

FIG. 4 illustrates the location of the various components of the system of FIG. 1B in one particular embodiment of the present invention, though the actual locations of the components may vary in further embodiments and should not limit the scope of the embodiment. In this example, the computing device 110 and the power control apparatus 130 are mounted to the exterior of the trailer 420 while the auxiliary system 170 and the power supply 120 are located in the interior of the trailer 420. It should be understood that any of these components could be located in other locations local to the trailer 420 (interior, exterior, in the tractor, etc.). A suitable protective covering may also be placed around any of these components. For example, the computing device 110 may have a protective covering to protect it from elements that could damage it since it is mounted on the exterior of the trailer 420.

As depicted in FIG. 4, the power supply 120 in this embodiment is used to supply power to the computing device 120 via the power control apparatus 130 and also to the auxiliary system 170. It should be understood that power supply 120 could further supply power to other systems or components as well. In a non-limiting example, the auxiliary system 170 may comprise a temperature control system for keeping the interior of trailer 420 at a constant temperature. In some embodiments, the primary function of the power supply 120 may be to supply power to the auxiliary system 170 and supplying power to the computing device 110 may be secondary.

As depicted in FIG. 4, the power control apparatus 130 is installed on the exterior of the trailer 420 on coupling line 450. As described above, the location of the power control apparatus 130 is not meant to limit the scope of the embodiment. For instance, the power control apparatus 130 could be located in the interior or exterior of the trailer 420 and could be coupled to other components, such as the trailer portion of the coupling mechanism 430. In the embodiment of FIG. 4, the detection apparatus 140 is incorporated within the power control apparatus 130 as a single device. In alternative embodiments, the detection apparatus 140 could be an independent apparatus local to the trailer 420. In this case, the detection apparatus 140 may be local to or remote from the power control apparatus 130 and is in communication with the power control apparatus 130 via wireless or wireline connections.

In one non-limiting example of the present invention, the power control apparatus 130 comprises an electro-pneumatic switch, such as RBE13250 from Meritor Wabco (2135 West Maple Road, Troy, Mich. 48084-7121), nominally used as a service circuit stoplight switch. Such electro-pneumatic switches are able to open and close a circuit based on the pressure in a pneumatic line. For example, RBE13250 is comprised of an air chamber containing a diaphragm, with a nozzle on one side of the diaphragm, the nozzle acting as an entry way into the chamber. The nozzle end of the electro-pneumatic switch may be installed on a pneumatic line, such as a pneumatic brake line, so that the air pressure in the chamber is similar to that of the air pressure in the pneumatic line. If the air pressure is high, the diaphragm expands away from the nozzle side. If the air pressure is low, the diaphragm relaxes. In essence, if the electro-pneumatic switch is coupled to a brake line of the trailer 420, the electro-pneumatic switch can detect a pressure change in the brake line and hence whether the brake line is engaged or disengaged.

In this non-limiting example, the power control apparatus 130 includes a single-pole, single throw switch on the side of the diaphragm, opposite the nozzle. Generally the poles are electrically accessible from the exterior of the air chamber, and include electrical pass-throughs which are suitably electrically insulated from the remainder of the chamber, the electrical pass-throughs being suitable to maintain the pressure in the chamber. The single-pole, single throw switch is adjacent to the diaphragm such that, when the diaphragm expands, the switch closes, completing a circuit between the external poles. The switch is also biased such that, when the diaphragm relaxes, the switch opens, breaking the circuit between the external poles. In this manner, the power control apparatus 130 is operable to react to a detected change in pressure in a pneumatic brake line that the power control apparatus 130 may be coupled to by causing the single-pole single throw switch to open or close as the diaphragm expands or contracts.

In one embodiment in which the power control apparatus 130 is the electro-pneumatic switch described above, the power control apparatus 130 can be installed on the pneumatic emergency brake line of the trailer coupling line 450 as depicted in FIG. 4. In this embodiment, the nozzle of the electro-pneumatic switch can be tapped or tee'd into the pneumatic emergency brake line, such that the diaphragm inside the electro-pneumatic switch expands when the emergency brake line of the trailer 420 is pressurized and relaxes when the pneumatic emergency brake line of the trailer 420 is not pressurized. In this embodiment, the single-pole single throw switch of the electro-pneumatic switch can be installed in the circuit between the power supply 120 and computing device 110.

As is well known to those of skill in the art, pneumatic emergency brake lines, or hydraulic emergency brake lines, on trailers are pressurized when the emergency brakes are to be released, and depressurized when the brakes are to be engaged. Further, a standard procedure in the trucking industry is to engage the emergency brake of the trailer whenever the tractor/trailer combination is parked or stationary. When the trailer is decoupled from the tractor, the emergency brake is engaged. Indeed, in many jurisdictions, the trucking industry is highly regulated and the conditions for engagement of the trailer emergency brakes are dictated by local authorities. In some jurisdictions, regulations dictate that the emergency brake line are to be engaged whenever the trailer is not in use, such as whenever the trailer is parked, stationary or decoupled from a tractor. In response to these regulations, many manufacturers of trailers in the trucking industry include automatic engagement of emergency brakes on trailers under these conditions as a standard feature of trailers. In some jurisdictions, regulations further dictate that this automatic engagement of emergency brakes is a mandatory feature. However, detection of changes in pressure in the brake line can occur whether the trailer 420 is mechanically coupled to the tractor 410 or not mechanically coupled to the tractor 410.

In the embodiment described above in which the power control apparatus 130 comprises a electro-pneumatic switch coupled to an emergency brake line, when the emergency brake line is depressurized, the power supplied from the power supply 120 can be decoupled from the computing device 110. Hence, when the emergency brake is engaged, the power to the computing device 110 can be stopped. In this embodiment, the vehicle can be considered not-in-use if the emergency brake is engaged (brake line not pressurized) and can be considered in-use if the emergency brake is not engaged (brake line pressurized). With the use of the electro-pneumatic switch as described as the combined detection apparatus 140 and the power detection apparatus 130, the switch between the power supply 120 and the computing device 110 can control power to the computing device 110 based upon the operational state of the vehicle; in this case, whether the vehicle is in-use or not-in-use. In this case, the power to the computing device 110 may be minimized when the trailer 420 is not-in-use, minimizing the drain on the power supply 120 when the operation of the computing device 110 may not be considered important.

It should be understood that in further embodiments, the combined detection apparatus 140 and power control apparatus 130 may include other types of detectors for detecting a change in the pressure of the emergency brake system. In a non-limiting example, the detector 145 may be a pressure transducer which detects changes in pressure electronically. Within this embodiment, the detector 145 can be installed on the pneumatic emergency brake system, such that changes in the pressure of the emergency brake system may be detected. Furthermore, the pressure transducer can be in communication with a switch for controlling power to the computing device 110. In this manner, the power to the computing device 110 may be controlled in response to changes in pressure in the pneumatic emergency brake line.

It should be understood that in further embodiments, the power control apparatus 130 may include other types of detectors and may detect the operational state of the trailer 320 in another manner as has been discussed in detail above.

It should be understood that the system of any one of FIGS. 1A-1H, 2A-2G may be installed in a variety of vehicles to detect an operational state of the vehicle and control power to a computing device 110 local to the vehicle. In one non-limiting example, the computing device 110 may comprise a telematics device or other vehicle tracking device such as the On Star™ System from General Motors Corporation of Detroit, Mich. In this case, the system of one of FIGS. 1A-1H, 2A-2G may be installed in a vehicle equipped with the On-Star system. It is well known that if a vehicle is parked or is stationary for a period of time, remote telematics devices, such as the On-Star system, shutdown after a period of time. For example, the On-Star system may shutdown after a period of two days. As these telematics devices are generally powered from the vehicle battery, this shutdown is performed in order to preserve the battery of the automobile, this battery power being necessary for the vehicle to start its engine. This shutdown of the telematics devices defeats one of the benefits of such devices, which is to provide a remote entity the ability to monitor the vehicle and the ability to access the vehicle systems in order to, for example, unlock the vehicle remotely if a user loses their keys. In situations where a user leaves their vehicle for a period of time that is longer than the shutdown window, a remote entity is unable to assist the user using the telematics device. For example, if the user loses the keys to their vehicle while on vacation, a remote entity may not be able to unlock the vehicle using the telematics devices since the telematics system will likely be shutdown.

The systems of the present invention disclosed above may be installed in a vehicle to control power to the telematics devices, the telematics devices corresponding to the computing device 110. In this manner, the working life of the telematics device may be increased while minimizing the drain on the vehicle battery, the vehicle battery corresponding to the power supply 120. In this non-limiting example, the detection apparatus 140 may include, as described above in detail, one or more detectors which may detect the operational state of one or more vehicle systems, the state of one or more elements in the vehicle environment and/or the state of the power supply life. In one embodiment, the detection apparatus 140 may detect if the vehicle is in-use or not-in-use. In one non-limiting example, if the power level of the power supply 120 is above a first pre-determined level (for example enough power to allow the vehicle to start its engine and for general vehicle function), power to the computing device 110 may be controlled to allow enough functionality for a remote entity to communicate with the computing device 110 via a wireless communication device. If the power level of the battery is below a second pre-determined level (for example enough power to allow the vehicle to start its engine and for a user to gain access to the vehicle), power to the computing device 110 may be controlled to turn off the computing device 110. If the power level of the battery is at an intermediate level between the first and second power levels (for example enough power to allow the vehicle to start its engine, but with reduced vehicle function), power to the computing device 110 may be controlled to allow enough functionality for a remote entity to periodically communicate with the computing device 110. It is understood that other intermediate functionalities will occur to one of skill in the art and are within the scope of the present invention. For example, in a further non-limiting embodiment, if the power level of the battery is at an intermediate level, power to the computing device 110 may be controlled to shut down the GPS to reduce the power draw on the vehicle battery, but maintain other telematics service. Within one non-limiting embodiment, a telematics service comprises control over power locks.

Within all embodiments described with reference to FIGS. 1A-1H, 2A-2G, 3, systems depicted are understood to be local to a vehicle. In this context, local to a vehicle is understood to be located in any location on the interior or exterior of the vehicle, such that the system is self-contained on or within the vehicle. In embodiments which include a plurality of vehicles, such as a tractor/trailer combination, local to a vehicle is understood to be located in any location on the interior or exterior of the plurality of vehicles, such that the system is self-contained on or within the plurality of vehicles. Within some embodiments, some aspects of the system may be located on the interior of one or more of the plurality of vehicles, while other aspects may be located on the exterior of one or more of the plurality of vehicles. In some embodiments, some aspects of the system are located on a first vehicle and other aspects are located on a second vehicle, but are communicatively coupled as described previously.

Persons skilled in the art will appreciate that there are yet more alternative implementations and modifications possible for implementing the present invention, and that the above implementations and examples are only illustrations of one or more embodiments of the present invention. The scope of the invention, therefore, is only to be limited by the claims appended hereto.

We claim:

1. A method of controlling power to a computing device on a vehicle, the computing device powered from a local power supply, the method comprising:
detecting an operational state of the vehicle; and
controlling the power level of the computing device based upon the operational state of the vehicle, wherein the power level of the computing device is controlled to a first power level when the vehicle is in a first operational state and controlled to a second power level when the vehicle is in a second operational state.

2. The method of claim 1, wherein detecting an operational state of the vehicle comprises detecting an in-use state of the vehicle and detecting a not-in-use state of the vehicle.

3. The method of claim 2, wherein the in-use state of the vehicle comprises the vehicle being in motion and the not-in-use state of the vehicle comprises the vehicle being stationary.

4. The method of claim 1, wherein detecting the operational state of the vehicle comprises detecting an operational state of at least one vehicle system.

5. The method of claim 4, wherein detecting the operational state of the at least one vehicle system comprises detecting an operational state of a braking system, wherein said first operational state comprises the brake system being disengaged and said second operational state comprises the brake system being engaged.

6. The method of claim 5, wherein the brake system comprises an emergency brake system.

7. The method of claim 4, wherein detecting the operational state of at least one vehicle system comprises detecting an operational state of an engine system, wherein said first operational state comprises the engine system being in an on state and said second operational state comprises the engine being in an off state.

8. The method of claim 4, wherein detecting the operational state of at least one vehicle system comprises detecting an operational state of an ignition system, wherein said first operational state comprises the ignition system being in an engaged state and said second operational state comprises the ignition system being in a disengaged state.

9. The method of claim 4, wherein detecting the operational state of at least one vehicle system comprises detecting an operational state of an exhaust system, wherein said first operational state comprises the exhaust system being in an in-use state and said second operational state comprises the exhaust system being in a not-in-use state.

10. The method of claim 4, wherein detecting the operational state of at least one vehicle system comprises detecting an operational state of a transmission system, wherein said first operational state comprises the transmission system being in an engaged state and said second operational state comprises the transmission system being in a disengaged state.

11. The method of claim 4, wherein detecting the operational state of at least one vehicle system comprises detecting an operational state of a coupling system, wherein said first operational state comprises the coupling system being coupled and said second operational state comprises the coupling system being uncoupled.

12. The method of claim 1, wherein detecting the operational state of the vehicle comprises detecting a state of the vehicle environment.

13. The method of claim 12, wherein detecting a state of the vehicle environment comprises detecting the motion of the vehicle, wherein said first operational state comprises the vehicle being in motion and said second operational state comprises the vehicle being stationary.

14. The method of claim 12, wherein detecting a state of the vehicle environment comprises detecting the vibration of the vehicle, wherein said first operational state comprises the vehicle vibrating and said second operational state comprises the vehicle not vibrating.

15. The method of claim 12, wherein detecting a state of the vehicle environment comprises detecting the proximity of the vehicle to a second vehicle, wherein said first operational state comprises the vehicle being in proximity to the second vehicle and said second operational state comprises the vehicle not being in proximity to the second vehicle.

16. The method of claim, 12, wherein detecting a state of the vehicle environment comprises detecting the presence of a vehicle driver, wherein said first operational state comprises a driver being present and said second operational state comprises the driver not being present.

17. The method of claim 1, wherein detecting the operational state of the vehicle comprises detecting a state of the power supply.

18. The method of claim 1, wherein detecting the operational state of the vehicle comprises a plurality of detecting the operational state of at least one vehicle system, detecting a state of the vehicle environment, and detecting a state of the power supply.

19. The method of claim 1, further comprising generating an indicator based on the operational state of the vehicle, and wherein said controlling the power level of the computing device is based on said indicator.

20. The method of claim 1, wherein the second power level is lower than the first power level.

21. The method of claim 20, wherein at the second power level, the computing device is in an off state and, at the first power level, the computing device is in a fully functional state.

22. The method of claim 20, wherein at the second power level, the computing device is in a partially functional state.

23. The method of claim 22, wherein said computing device comprises a plurality of components; and at the second power level, at least one first component of the computing device is functional and at least one second component of the computing device is not functional.

24. The method of claim 22, wherein the at least one first component comprises a wireless communication component, and the at least one second component comprises a GPS component.

25. The method of claim 1, wherein the computing device is controlled to a third power level when the vehicle is in a third operational state, and at the third power level the computing device is in a partially functional state.

26. The method of claim 25, wherein at the third power level, at least one first component of the computing device is functional and at least one second component of the computing device is not functional.

27. The method of claim 1, wherein said computing device comprises a plurality of components; and wherein at least one component of the computing device is always powered.

28. An apparatus for controlling power to a computing device on a vehicle, the computing device powered from a local power supply, the apparatus comprising:
a detection apparatus for detecting an operational state of the vehicle; and
a power control apparatus, communicatively coupled to said detection apparatus, said power control apparatus operable to control the power level of the computing device based upon the operational state of the vehicle, wherein the power level of the computing device is controlled to a first power level when the vehicle is in a first operational state and controlled to a second power level when the vehicle is in a second operational state.

29. The apparatus of claim 28, wherein said detection apparatus comprises at least one detector in communication with at least one vehicle system, wherein said at least one detector is operable to detect the operational state of the vehicle by detecting the operational state of the at least one vehicle system.

30. The apparatus of claim 29, wherein to detect the operational state of the at least one vehicle system, said at least one detector is operable to detect the operational state of a braking system, and wherein said first operational state comprises the brake system being disengaged and said second operational state comprises the brake system being engaged.

31. The apparatus of claim 30, wherein the brake system comprises an emergency brake system.

32. The apparatus of claim 29, wherein to detect the operational state of the at least one vehicle system, said at least one detector is operable to detect the operational state of an engine system; and wherein said first operational state comprises the engine system being in an on state and said second operational state comprises the engine being in an off state.

33. The apparatus of claim 29, wherein to detect the operational state of the at least one vehicle system, said at least one detector is operable to detect the operational state of an ignition system; and wherein said first operational state comprises the ignition system being in an engaged state and said second operational state comprises the ignition system being in a disengaged state.

34. The apparatus of claim 29, wherein to detect the operational state of the at least one vehicle system, said at least one detector is operable to detect the operational state of an exhaust system; and wherein said first operational state comprises the exhaust system being in an in-use state and said second operational state comprises the exhaust system being in a not-in-use state.

35. The apparatus of claim 29, wherein to detect the operational state of the at least one vehicle system, said at least one detector is operable to detect the operational state of a transmission system; and wherein said first operational state comprises the transmission system being in an engaged state and said second operational state comprises the transmission system being in a disengaged state.

36. The apparatus of claim 29, wherein to detect the operational state of the at least one vehicle system, said at least one detector is operable to detect the operational state of a coupling system; and wherein said first operational state comprises the coupling system being coupled and said second operational state comprises the coupling system being uncoupled.

37. The apparatus of claim 36, wherein said vehicle comprises a trailer.

38. The apparatus of claim 28 wherein said detection apparatus comprises at least one detector operable to detect the operational state of the vehicle by detecting a state of the vehicle environment.

39. The apparatus of claim 38, wherein said at least one detector is operable to detect the motion of the vehicle, wherein said first operational state comprises the vehicle being in motion and said second operational state comprises the vehicle being stationary.

40. The apparatus of claim 38, wherein said at least one detector is operable to detect the vibration of the vehicle, wherein said first operational state comprises the vehicle vibrating and said second operational state comprises the vehicle not vibrating.

41. The apparatus of claim 38, wherein said at least one detector is operable to detect the proximity of the vehicle to a second vehicle, wherein said first operational state comprises the vehicle being in proximity to the second vehicle and said second operational state comprises the vehicle not being in proximity to the second vehicle.

42. The apparatus of claim 38, wherein said at least one detector is operable to detect the presence of a vehicle driver, wherein said first operational state comprises a driver being present and said second operational state comprises the driver not being present.

43. The apparatus of claim 28, wherein detecting the operational state of the vehicle comprises detecting a state of the power supply.

44. The apparatus claim 28, wherein detecting the operational state of the vehicle comprises a plurality of detecting the operational state of at least one vehicle system, detecting a state of the vehicle environment, and detecting a state of the power supply.

45. The apparatus of claim 28, wherein said detection apparatus is further operable to generate an indicator based on the detected operational state of the vehicle, and said power control apparatus is operable to control power to the computing device based on said indicator.

46. The apparatus of claim 28, wherein the second power level is lower than the first power level.

47. The apparatus of claim 46, wherein at the second power level, the computing device is in an off state and, at the first power level, the computing device is in a fully functional state.

48. The apparatus of claim 46, wherein at the second power level the computing device is in a partially functional state.

49. The apparatus of claim 48, wherein said computing device comprises a plurality of components; and at the second power level, at least one first component of the computing device is functional and at least one second component of the computing device is not functional.

50. The apparatus of claim 49, wherein the at least one first component comprises a wireless communication component and the at least one second component comprises a GPS component.

51. The apparatus of claim 28, wherein said computing device is controlled to a third power level when the vehicle is in a third operational state, and at the third power level the computing device is in a partially functional state.

52. The apparatus of claim 51, wherein at the third power level, at least one first component of the computing device is functional and at least one second component of the computing device is not functional.

53. The apparatus of claim 28, wherein said computing device comprises a plurality of components; and wherein at least one component of the computing device is always powered.

54. The apparatus of claim 28, wherein said detection apparatus is in wireless communication with said power control apparatus.

55. The apparatus of claim 28, wherein said detection apparatus is in wireline communication with said power control apparatus

56. The apparatus of claim 28, wherein said detection apparatus is integrated into said power control apparatus.

57. The apparatus of claim 56, wherein said power control apparatus comprises an electropneumatic switch.

58. An apparatus for controlling power to a computing device on a vehicle, the computing device powered from a local power supply, the apparatus comprising:
means for detecting an operational state of a vehicle; and
means for controlling the power level of the computing device based upon the operational state of the vehicle, wherein the power level of the computing device is controlled to a first power level when the vehicle is in a first operational state and controlled to a second power level when the vehicle is in a second operational state.

59. A system for controlling power to a computing device on a vehicle, the computing device powered from a local power supply, the system comprising:
a detection apparatus operable to detect an operational state of the vehicle and to transmit an indicator based on the operational state of the vehicle; said indicator being operable to cause said power control apparatus to control power to the computing device.

60. The system of claim 60, further comprising said power control apparatus.

61. A system for controlling power to a computing device on a vehicle, the computing device powered from a local power supply, the system comprising:
a power control apparatus operable to receive an indicator that represents an operational state of said vehicle, and to control the power level of the computing device based upon said indicator; wherein the power level of the computing device is controlled to a first power level when the vehicle is in a first operational state and controlled to a second power level when the vehicle is in a second operational state.
